(19) United States
(12) Patent Application Publication
(10) Pub. No.: US 2021/0060530 A1
(43) Pub. Date: Mar. 4, 2021

(54) Solvent-free Extractive Separation

(71) Applicant: Regents of the University of Minnesota, Minneapolis, MN (US)

(72) Inventors: Marc A. Hillmyer, Minneapolis, MN (US); Jay Werber, Minneapolis, MN (US)

(21) Appl. No.: 17/003,538

(22) Filed: Aug. 26, 2020

Related U.S. Application Data
(60) Provisional application No. 62/891,854, filed on Aug. 26, 2019.

(51) Int. Cl. B01J 20/28; B01J 20/26; C01G 3/00

(52) U.S. Cl. CPC B01J 20/28016; C01G 3/003; B01J 20/267

(57) ABSTRACT

Provided herein are polymeric capsules and methods for solvent-free extractive separation of ions from mixed solutions using polymeric capsules. The capsules can comprise a polymeric shell encasing an inner chamber and a lipophilic ligand within the polymeric shell. Methods for making the polymeric capsules are also provided.

### CROSS-REFERENCE TO RELATED APPLICATION

This application is a utility application and claims the benefit of U.S. Application No. 62/891,854, filed Aug. 26, 2019. The disclosure of the foregoing application is hereby incorporated by reference in its entirety.

### TECHNICAL FIELD

This document relates to solvent-free extractive separation of ions, and more particularly to particles, such as polymeric capsules, for extracting ions from mixed solutions. This document further includes methods and materials for making and using such polymeric capsules.

### BACKGROUND

Selective separations of ions are often technically challenging, but important for various applications, including in the chemical and food industries, waste treatment, and hydrometallurgy. For example, metals play an essential role in modern society, but, when dissolved as ions in water, can be highly hazardous to human and environmental health (e.g., lead, mercury, radioactive species). Selective separations of metals are critical to efficient metal production and environmental management. Liquid-liquid extraction, also called solvent extraction (SX), is a common method for selective separations of aqueous metals. For example, SX is often the preferred choice in the cleanup of radioactive Cs⁺ from contaminated nuclear production sites. However, SX requires a large organic solvent inventory, is susceptible to loss of solvent and ligand into the aqueous phase, and is limited by the metal/ligand stoichiometry and the equilibrium established during extraction and stripping. Facilitated transport membranes have also received extensive research interest for selective separations of aqueous metals, however, their instability has severely limited industrial implementation.

### SUMMARY

Provided herein are particles, e.g., polymeric capsules, for extracting metal ions from mixed solutions. In some embodiments, the capsules can serve as a new format to enable stable, selective, and rapid facilitated transport of metal ions. The capsules can comprise a polymeric shell encasing an inner chamber and a lipophilic ligand within the polymeric shell. This document further includes methods for making such polymeric capsules, including, e.g., polymersomes. This document further includes methods for using polymeric capsules for extracting metal ions from mixed solutions.

In a first general aspect, this document provides polymeric capsules comprising: a polymeric shell encasing an inner chamber; and a lipophilic ligand within the polymeric shell.

In a second general aspect, this document provides a method of making a polymeric capsule comprising: forming, in a strip solution or a metal salt solution, a polymersome, from at least one amphiphilic block polymer having a hydrophobic block and a hydrophilic block; and exposing the capsule to a solution comprising a lipophilic ligand. In some embodiments, the capsule can be formed in a metal salt solution, and further comprising exposing the polymersome to a strip solution. In some embodiments, the metal salt solution can be MgCl2 or CaCl2.

In a third general aspect, this document provides a method of extracting target ions from a mixed solution comprising: exposing the mixed solution to polymeric capsules to produce a second solution, wherein the capsules comprise: a polymeric shell encasing an inner chamber; a lipophilic ligand within the polymeric shell; and a first strip solution contained within the inner chamber of the capsule. In some embodiments, the lipophilic ligand can specifically bind the target ion. In some embodiments, the method can further comprise removing the second solution from the capsules. In some embodiments, the method can further comprise exposing the capsules to a second strip solution to obtain a solution enriched in the target metal ion and regenerate the strip solution within the capsules; and collecting the target ions. In some embodiments, removing the second solution can comprise washing to remove non-target ions. In some embodiments, removing non-target ions can comprise a size-based separation technique or a packed bed technique. In some embodiments, the size-based separation technique can be filtration with porous membranes.

In a fourth general aspect, this document provides a method of making a polymeric capsule comprising: mixing, in a solvent, a lipophilic ligand with at least one amphiphilic block polymer having a hydrophobic block and a hydrophilic block; evaporating the solvent to produce a ligand-polymer mixture; adding an aqueous solution to the ligand-polymer mixture; and allowing the capsules to form.

In some embodiments, the polymeric capsules may optionally include one or more of the following features. The shell can comprise one or more amphiphilic block polymers. The one or more amphiphilic block polymers can comprise a hydrophilic block that is uncharged, cationic, zwitterionic, or anionic. The polymeric shell can comprise a water-insoluble polymer with a glass transition temperature below 20° C. The polymeric shell can comprise a plasticizer and a water-insoluble polymer with a glass transition temperature above 20° C. The capsule can be a polymersome. The polymeric shell can comprise at least one polymer selected from poly(isoprene), poly(chloroprene), poly(butadiene), poly(myrcene), poly(farnesene), poly(citrenellol), hydrogenated poly(isoprene), hydrogenated poly(butadiene), polyethylene, polypropylene, polydimethylsiloxane, polymers from styrenic derivatives, polymers from acrylic derivatives, polymers from acrylamide derivatives, and polymers from siloxane derivatives. The one or more amphiphilic block polymers can comprise a hydrophilic block comprising a monomer selected from ethylene oxide, allyl alcohol, methyl oxazoline, acrylamide and derivatives thereof, zwitterionic derivatives of styrenic monomers and vinylpyridine, and cationic derivatives of styrenic monomers and vinylpyridine, and combinations thereof. The hydrophilic block can comprise at least one of poly(ethylene oxide), poly(allyl alcohol), poly(2-methyl-2-oxazoline), and poly(acrylamide). The one or more amphiphilic block polymers can comprise a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof. The hydrophobic block can comprise at least one of poly(butadiene), poly(styrene), poly(isoprene), and poly(dimethyl siloxane). The lipophilic ligand can be selected from oxime derivatives, phosphoric acid derivatives, phosphinic acid derivatives, phosphonic acid derivatives, diketone derivatives, amine derivatives, ketone derivatives, polyether derivatives, crown ether derivatives, cryptand derivatives, calixarene derivatives, and combinations thereof. The capsule can further comprise a strip solution contained within the inner chamber of the capsule. The strip solution can be an acid solution, and optionally, wherein the acid is hydrochloric acid, nitric acid, or sulfuric acid. At least one dimension of the capsule can be from about 10 nm to about 5 mm. One dimension of the capsule can be from about 10 nm to about 10 μm. The shell can be from about 1 nm to about 20 μm thick. The lipophilic ligand can interact with metal ions. The lipophilic ligand can be a freely diffusing ligand. The lipophilic ligand can be covalently bonded to a polymer in the shell. The shell can be cross-linked. the polymeric shell can comprise, or can consist essentially of, a hydrophobic polymer. In some embodiments, the lipophilic ligand interacts with metal ions. In some embodiments, the lipophilic ligand is a freely diffusing ligand. In some embodiments, the lipophilic ligand is covalently bonded to a polymer in the shell. In some embodiments, the shell comprises a water-insoluble polymer and one or more surfactants. In some embodiments, the one or more surfactants comprise amphiphilic polymers. In some embodiments, the capsule comprises a multi-block copolymer comprising a hydrophilic segment, a hydrophobic segment, and an acidic segment.

In some embodiments, a method of extracting target ions from a mixed solution comprising: exposing the mixed solution to polymeric capsules to produce a second solution, wherein the capsules comprise: a polymeric shell encasing an inner chamber; a lipophilic ligand within the polymeric shell; and a first strip solution contained within the inner chamber of the capsule.

In some embodiments, the lipophilic ligand specifically binds the target ion. In some embodiments, the method comprising removing the second solution from the capsules. In some embodiments, the method further comprising: exposing the capsules to a second strip solution to obtain a solution enriched in the target metal ion and regenerate the first strip solution within the capsules; and collecting the target ions. In some embodiments, the removing the second solution comprises washing to remove non-target ions by using a size-based separation technique or a packed bed technique. In some embodiments, the lipophilic ligand is selected from oximes, phosphoric acid derivatives, phosphinic acid derivatives, phosphonic acid derivatives, diketone derivatives, amine derivatives, ketone derivatives, polyether derivatives, crown ether derivatives, cryptand derivatives, and calixarene derivatives. In some embodiments, the first strip solution, second strip solution, or combination thereof, is an acid solution, and optionally, wherein the acid is hydrochloric acid or sulfuric acid.

The polymeric capsules and methods of solvent extraction described herein provide several advantages. For example, the coupling of the extraction and stripping phases using polymeric capsules can allow for dramatic reductions (e.g., ˜10⁴-fold) in ligand requirements. In some embodiments, polymeric capsules can serve as a general format for the selective separations of metals, without the need for organic solvents. In some embodiments, polymeric capsules may be useful for any application of SX, e.g., reversible extraction of a metal ion into a nonpolar phase using a selective ligand that is soluble in organic solvents and relatively insoluble in water. In some embodiments, the polymeric capsules can have high surface area, high dispersibility, and low wall-thickness, which can result in rapid kinetics, for example ˜99% metal removal in <2 min. In some embodiments, polymeric capsules described herein can have a selectivity at least as good as that of solvent extraction (SX) using the same ligand. Some embodiments of polymeric capsules described herein can be used for any application of SX. As another example of advantages, the low ligand requirements of some embodiments of the polymeric capsule provided herein can improve selectivity through the use of highly-selective, expensive ligands. The use of polymeric capsule in solvent extraction can have far-reaching implications for the efficient and rapid selective separations of aqueous metals, which could impact the fields of environmental remediation, metal production, and electronics recycling.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a plot of a typical extraction curve for a target divalent metal (M²⁺). Curves were calculated for Cd²⁺ and the organophosphate ligand D2EPA at 10 wt % in tetradecane, using the equilibrium constant, K=0.0258 [8]. The curve for K/100 is for a hypothetical divalent ion that interacts more weakly with the ligand, causing the extraction curve to shift to higher pH. Feed is 100 ppm Cd²⁺ and organic/aqueous volume ratio is 1:1. Operating conditions 1 and 2 refer to potential extraction and stripping conditions, as depicted in FIGS. 2A and 2B.

FIG. 2A is a schematic showing an exemplary operation of solvent extraction. Operating conditions 1 and 2 refer to potential extraction and stripping conditions, respectively.

FIG. 2B is a schematic showing an exemplary operation of facilitated transport membranes coupling the extraction and stripping steps of solvent extraction. Operating conditions 1 and 2 refer to potential extraction and stripping conditions, respectively.

FIG. 3 is a schematic of an exemplary polymeric capsule.

FIG. 4 is a schematic of an exemplary polymeric capsule that is a polymersome, and its constituent parts. Formation of metal-selective polymersomes (MSPs) can occur from the self-assembly of amphiphilic block polymers in water and dissolution into the nonpolar domain of lipophilic ligands as metal carriers. Such polymersomes can encapsulate a strip solution, such as an acid (pH˜0-5) solution.

FIG. 5 is a schematic of an exemplary envisioned semi-continuous extraction process using polymeric capsules such as metal selective polymersomes. Target metal ions can be transported into the capsules, while the unextracted (raffinate) solution is pumped through porous membranes that exclude the capsules. After extraction, a wash step can remove residual non-target ions outside of the capsules, and a strip step can allow for recovery of the target ion while regenerating the encapsulated strip solution.

FIG. 6 is a plot of ligand requirements according to Example 1.

FIG. 7 is a cryo-electron microscopy image of polymersomes formed from block polymers with poly(1,2-butadiene) (PB) as the hydrophobic block.

FIG. 8 is a plot showing Solute permeability (P) in m/s through polymersomes compared with the hexadecane/water partition coefficient (K_{hdw}) of each solute. Trendlines have a slope of 1, indicating that polymersome permeability is similar to that of a thin slab of nonpolar solvent (e.g., hexadecane). PDMS: poly(dimethylsiloxane).

FIG. 9 is a plot showing estimated solute diffusivity (Dₛₒₗᵤₜₑ) relative to that of water (D_{water}) in bulk water, PDMS-based polymersomes, and PB-based polymersomes. Solute radius is given as the van der Waals radius. Diffusivities for the polymersomes were estimated from the data shown in FIG. 8 and the solution-diffusion model, assuming the nonpolar block behaves like hexadecane (i.e., P=K_{hdw}D/δ). Diffusivities for the solutes in bulk water were estimated from the Hayduk-Laudie equation.

FIG. 10 is a schematic of metal concentration profiles in facilitated transport processes according to Example 1. The gray shaded region represents a membrane of thickness δ, in which the metal/ligand (M/L) complex diffuses down its concentration gradient. Dashed lines indicate the start of unstirred layers, also called boundary layers, of thickness δᵤₗ.

FIG. 11 is a plot of the effect of unstirred layers on achievable metal flux. Characteristic unstirred layer thicknesses (δᵤₗ) of 200 nm and 20 μm were used for polymersomes and planar membranes, respectively [24], [25]. Much greater fluxes and effective permeabilities are achievable for MSPs. Aqueous metal ions were assumed to have a diffusivity of 10⁻⁹ m²/s. The membrane was modeled as a 10-nm thick nonpolar layer with 10 wvt % D2EHPA [8]. The feed, [M²⁺]_{F}, was 100 ppm Cd²⁺, the feed pH was 4, and the strip pH was 0.

FIG. 12 is a plot showing the modeled effect of diffusivity (D) of the metal/ligand complex on metal removal using MSPs with 1 wt % D2EHPA.

FIG. 13 is a plot showing the effect of carrier concentration on metal removal using MSPs, assuming D=10⁻¹² m²/s. The initial feed ([M²⁺]₀) was 100 ppm Cd²⁺, the initial feed pH was 4, and the initial strip pH was 0. MSPs occupied 1% of the total volume and were modeled with 10-nm thick nonpolar layers and 300-nm diameters.

FIG. 14A is a plot showing modeled separation of divalent metals based on differences in equilibrium coefficient (K) for normalized metal removal. For clarity, only one curve for the target metal M₁²⁺ is shown (black), corresponding to K₁/K₂=100. Removal of M₁²⁺ was slightly slower for K₁/K₂=10.

FIG. 14B is a plot showing relative fluxes of M₁²⁺ and M₂²⁺ for varying ratios of K for modeled separation of divalent metals based on differences in equilibrium coefficient (K). Relative flux can be a measure of the instantaneous selectivity of the process.

FIG. 14C is a plot showing overall process selectivity (β), defined in Eqn. 10, for modeled separation of divalent metals based on differences in equilibrium coefficient (K). Vertical dashed lines indicate the point at which 99% of the target metal (M₁²⁺) was removed. The model assumed starting concentrations of 100 ppm (corresponding to Cd²⁺), MSPs with 10-nm thick walls and 300-nm diameter, 1% MSP volume relative to the total system, initial feed pH of 4, and initial strip pH of 0. K1 was set to 0.0258 [8], and the concentration of D2EHPA was 1 wt %. The diffusivity was set to 10⁻¹³ m²/s. Boundary layer thicknesses were set to 200 nm, with aqueous ion diffusivities of 10⁻⁹ m²/s.

FIG. 15 is a plot showing concentration profiles during modeling. The gray shaded area is the membrane of thickness δ. Vertical black dashed lines indicate the start of boundary layers of thickness δᵤₗ. The subscripts “F” and “S” refer to feed and strip, respectively. “b” refers to the bulk solution. [M²⁺] and [H⁺] refer to the aqueous concentrations of the target metal and protons, respectively. To simplify modeling, concentration polarization of protons was neglected. [ML] and [L] refer to the concentrations of metal/ligand complex and free ligand, respectively, which are referred to in the main proposal as [MR₂(n−1)(RH)₂] and [(RH)₂], respectively. It was assumed during modeling that the total ligand concentration, L-r, was constant at any point x within the membrane. The profiles shown are for the simpler one-metal case (FIGS. 12 and 13). When a second metal was considered, similar aqueous metal and metal/ligand complex concentrations were included.

FIG. 16 is a plot of the expected mechanical integrity of crosslinked and uncrosslinked MSPs with increasing vesicle radius. The maximum osmotic pressure differences and corresponding concentrations of HCl in the internal MSP strip solution are calculated using Eqns. 11 and 12 of Example 3. The rupture tensions (n) are published values for crosslinked poly(ethylene oxide)-b-poly(1,2-butadiene) (PEO-PB) and its uncrosslinked analog PEG-b-poly(ethyl ethylene) (PEO-PEE) [17].

FIG. 17 shows schematics of two lab-scale methods for assessing the kinetics of metal removal using exemplary MSPs according to Example 4.

FIG. 18 is a schematic of an exemplary polymeric capsule containing polyacids.

FIG. 19 is a schematic of an exemplary polymeric capsule containing block copolymers with one or more polyacid segments.

FIG. 20 is a schematic of an exemplary polymeric capsule containing tri-block polymers with one or more polyacid segments.

FIG. 21 is a plot showing ion concentration in a 10-mL aqueous solution in relation to the mass of Lix 84-I, a commercial phenolic oxime ligand, that was mixed with the aqueous solution.

FIG. 22A is a schematic of an exemplary test configuration used for determining H⁺ and Cu²⁺ ion transport over planar facilitated transport membrane.

FIG. 22B is a plot of H⁺ and Cu²⁺ concentration over time for a planar facilitated transport membrane. Feed and Strip refer to the left and right sides of the schematic in FIG. 22A, respectively.

FIG. 23 is a plot of H+ and Cu2+ concentration over time in an aqueous solution mixed with sorbitan trioleate-stabilized capsules that incorporated Lix 84-I ligands.

FIG. 24 is an image of sorbitan trioleate-stabilized capsules (on left) and PVB3MA-PI stabilized capsules (on right).

FIG. 25 is a plot of H+ and Cu2+ concentration over time in an aqueous solution mixed with PVB3MA-PI stabilized capsules that incorporated Lix 84-I ligands.

FIG. 26 is a plot of carboxyfluorescein (CF) absorbance over wavelength (in nm) showing measured CF that was not encapsulated during the preparation of capsules stabilized by PVB3MA-PI.

Like reference symbols in the various drawings indicate like elements.

### DETAILED DESCRIPTION

Provided herein are polymeric capsules, and methods for making and using polymeric capsules, for extracting metal ions from mixed solutions.

Metals provide structure and strength to buildings, transmit electricity through wires, and form the intricate circuitry of electronic devices. Human use of metals has grown increasingly complex. For example, a single mobile phone today can contain more than seventy different elements, most of which are metals [1]. This complexity can hinder responsible life-cycle management; many metals can have near-zero rates of recycling [2], while many others are not produced locally, which can put supply chains at risk.

Additionally, aqueous solutions of metal ions can be toxic (e.g., lead, mercury). Effective management methods should be employed at all stages (production, usage, and disposal) to ensure that dissolved metals do not contaminate the environment and endanger public health. One example of this dynamic is the nuclear energy sector. While the production of high-quality fuel remains important, management of the resulting waste streams and the contaminated legacy production sites can sometimes be more challenging. According to the Department of Energy's report on Basic Research Needs for Environmental Management [3], cleanup of the remaining contaminated sites and safe disposal of resulting radioactive waste is expected to cost over $300 billion. New technologies are needed to decrease this enormous cost [3].

Selective separations can allow efficient metal utilization, production, and recovery. In metal production, the decreasing quality of ore and desire to decrease the energetic demand of metal production have led to increased use of hydrometallurgy, in which metals are leached from ores into dilute acid, separated in solution, and reduced to form the pure metal. The solution-phase technique used for these separations is typically liquid-liquid extraction, also called solvent extraction (SX) [3]-[5]. In SX, a lipophilic ligand (also called a receptor or extractant) in an organic phase selectively and reversibly binds a target metal ion, extracting it from the aqueous solution into the organic phase. The metal can then be recovered in a stripping step, which can, in some cases, include contacting the metal-loaded organic phase with an acidic aqueous (strip) solution. Simple extractants such as organophosphates, -amines, and -oximes are often used in metal production, whereas more complex, and sometimes more efficient, extractants are typically used in high-value separations, such as the use of calixarenes in the caustic side solvent extraction (CSSX) process to remove radioactive cesium from the Savannah River Site [3]. Decades of research has resulted in highly selective ligands that can allow for exquisitely selective separations.

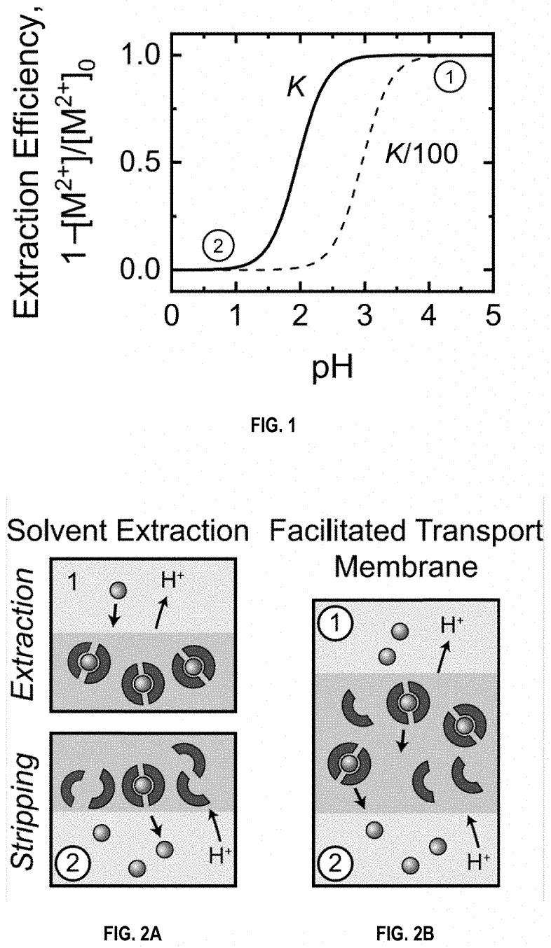

While SX is a mature and effective technology that builds on decades of research on metal ligand interactions, it can have several important limitations. First, it can require a large solvent inventory, which can pose a safety concern and risk for environmental discharge. Second, SX can suffer from ligand and solvent loss due to solvent entrainment in the aqueous phase (e.g., through the formation of emulsions). Such loss of ligand can be particularly critical for expensive ligands such as the calixarenes used in CSSX. To help recover ligand, extra steps are often necessary. For example, the CSSX process employs a coalescer and decanter to recover ligand-bearing organic phase that are present in the aqueous stream as small droplets <10 μm in diameter [6]. Third, SX is an equilibrium process (see, e.g., FIG. 1) and is limited by the equilibria established during extraction and stripping. This equilibrium-based processing can result in stoichiometric limitations. For example, if n ligands complex with one metal ion during extraction, then to remove a certain quantity of metal in a cycle of SX, at least n-times as much ligand is needed. This limitation can drive up the cost of a given process due to material (ligand) expense and expanded equipment needs.

To address these issues, facilitated transport membranes were explored extensively in the 1980's and 1990's [4], [7]. These membranes place the ligand-containing organic phase between the aqueous feed and aqueous strip solutions as a thin barrier to couple the two extraction and stripping steps (see, e.g., FIG. 2B). Typically, after a metal ion is bound by ligands, the metal-ligand complex diffuses across the membrane and releases the metal ion into the strip solution, exchanging the metal ion with protons to regenerate the free ligand.

Facilitated transport membranes thus far have predominantly taken two major forms. In supported liquid membranes, the liquid organic phase fills the pores of a hydrophobic membrane, which can retain the liquid phase by capillary forces. In emulsion liquid membranes, water-in-oil-in-water emulsions are created such that strip solution compartments are contained within small droplets of the organic phase, which can enable fast separation kinetics due to large surface areas.

Due to the chemical selectivity of metal-ligand interactions, facilitated transport membranes can be capable of exquisite separations (e.g., separating mixtures of divalent metal ions) that are not attainable using traditional membranes, which typically separate based on size or charge [7], [9]. Additionally, facilitated transport membranes use a chemical gradient (e.g., a proton gradient) to actively drive transport, allowing for the target metal to move against its concentration gradient (i.e., become concentrated in the strip solution). However, facilitated transport membranes can be unstable [7]. Supported liquid membranes can be susceptible to catastrophic pore wetting with the aqueous phase, caused by dissolution of the organic phase or osmotic pressure differences. Emulsion liquid membranes are complex to manage and can be susceptible to spontaneous break-up. Polymeric facilitated transport membranes have gained recent interest because of their enhanced stability, but have typically been flux-limited due to large thicknesses (˜30 μm) combined with increased diffusion resistance of the polymer matrix relative to a liquid organic phase [7], [10]. For facilitated transport membranes to successfully address the limitations of solvent extraction, fundamentally new designs are necessary.

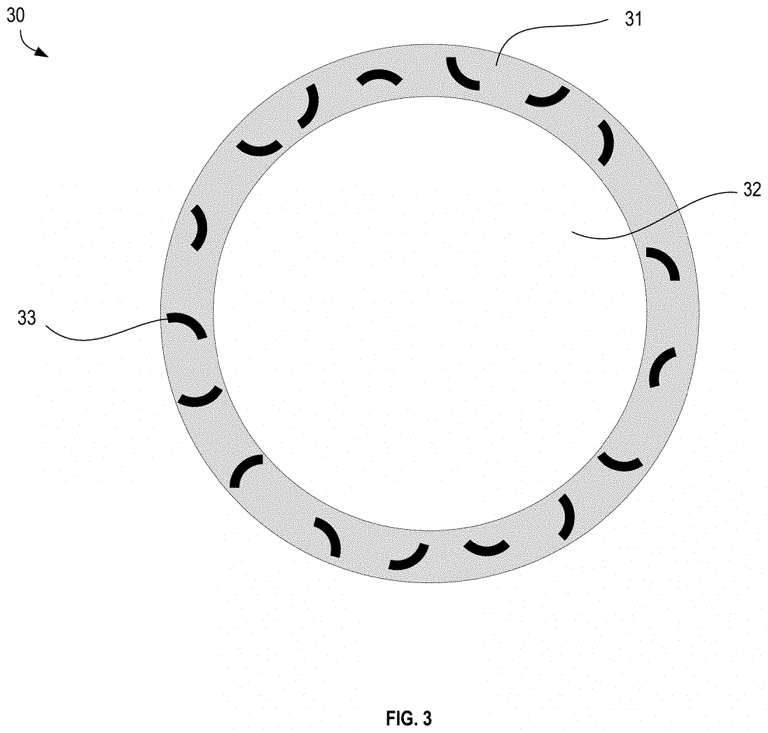

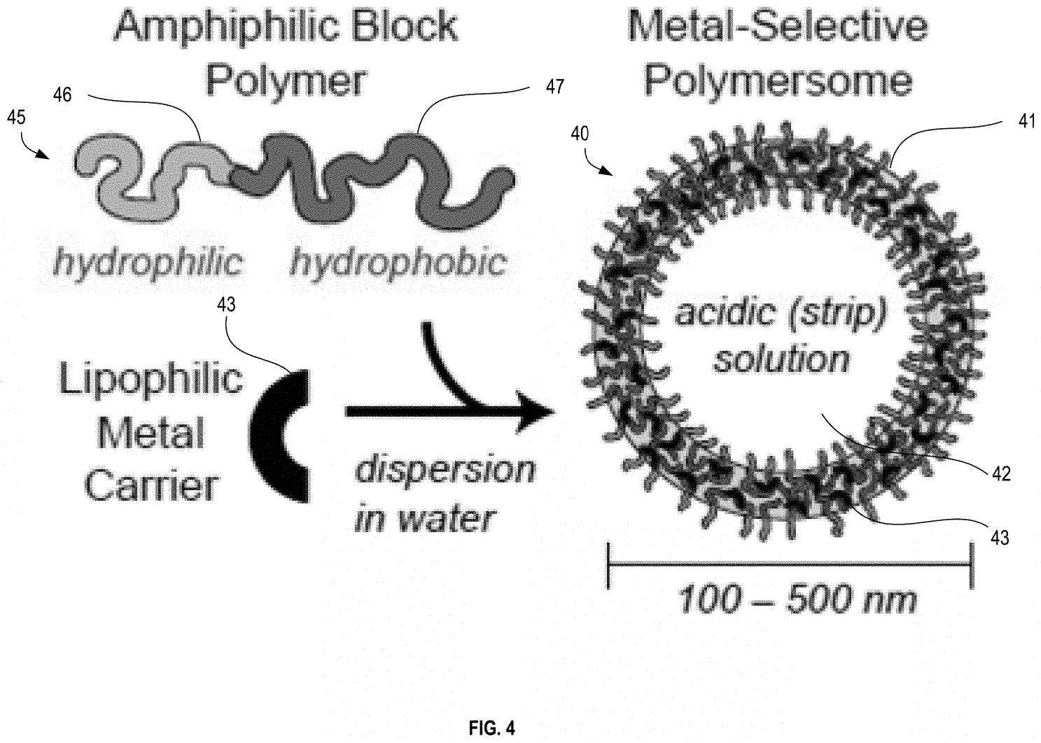

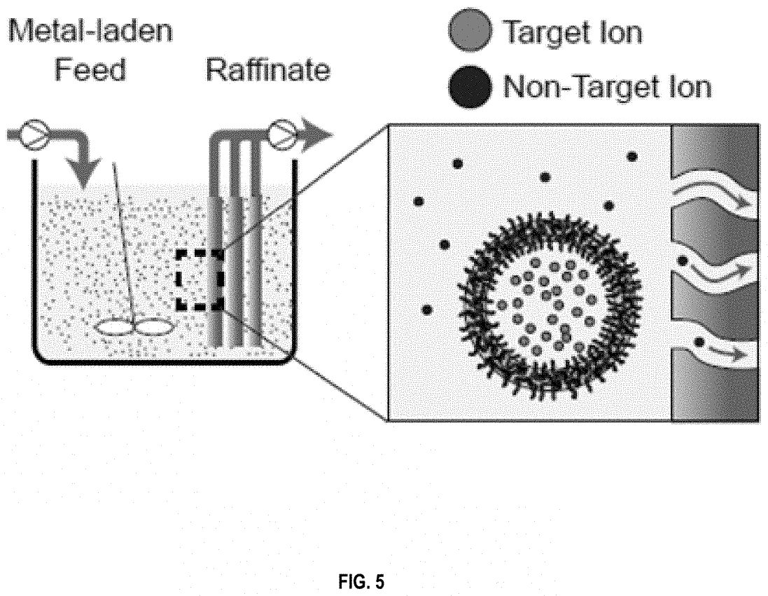

As provided herein, polymeric capsules can provide a new format to enable stable, selective, and rapid facilitated transport of metal ions for metal separations (see, e.g., FIGS. 3 and 4). In some embodiments, the capsules can comprise a polymeric shell encasing an inner chamber and a lipophilic ligand within the polymeric shell. In some embodiments, dissolution or covalent bonding of lipophilic ligands in the polymeric shell can allow for selective transport of target ions (e.g. target metal ions), as generally depicted in FIG. 2B. In some embodiments of the methods described herein, size-based separation techniques such as filtration with macroporous membranes can be used to rapidly and completely separate unextracted ions from metal-loaded polymeric capsules. See, e.g., FIG. 5. In some embodiments, extraction, wash, and strip steps can be alternated to allow for semi-continuous removal and recovery of the target metal(s). In some embodiments, during the strip step, the polymeric capsules would be placed in fresh strip solution to simultaneously recover the target species (e.g., target metals) and regenerate the entrapped strip solution. The target species can be an ion to be selectively extracted. Depending on the application, the target ion and/or the non-target ion(s) can be a valuable or non-valuable species. The target species can be a species of interest selected for separation or removal from a mixed solution. The target can, in some embodiments, be desired for separation or removal in order to be used, e.g., in a later process, or for appropriate disposal or recycling of certain undesirable wastes. Non-target species can also be present in mixed solutions. In some embodiments, non-target species can include waste species or other species that are not of interest or not selected for removal or separation other than for the purpose of separating a target species from the mixture.

A polymeric capsule 30 according to one exemplary embodiment is shown in FIG. 3. The polymeric capsule can comprise a polymeric shell 31 encasing an inner chamber 32, and one or more lipophilic ligands 33 within the polymeric shell.

In some embodiments, at least one dimension of the polymeric capsules can range from about 10 nm to about 5 mm, from about 10 nm to about 4 mm, from about 10 nm to about 3 mm, from about 10 nm to about 2.5 mm, from about 10 nm to about 2 mm, from about 10 nm to about 1.5 mm, from about 10 nm to about 1 mm, from about 10 nm to about 0.9 mm, from about 10 nm to about 0.8 mm, from about 10 nm to about 0.7 mm, from about 10 nm to about 0.6 mm, from about nm to about 0.5 mm, from about 10 nm to about 0.4 mm, from about 10 nm to about 0.3 mm, from about 10 nm to about 0.2 mm, from about 10 nm to about 0.1 mm, from about 0.5 mm to about 5 mm, from about 0.6 mm to about 5 mm, from about 0.7 mm to about 5 mm, from about 0.8 mm to about 5 mm, from about 0.9 mm to about 5 mm, from about 1 mm to about 5 mm, from about 0.5 mm to about 5 mm, from about 1.5 mm to about 5 mm, from about 2 mm to about 5 mm, from about 2.5 mm to about 5 mm, from about 3 mm to about 5 mm, from about 4 mm to about 5 mm, from about 10 nm to about 100 μm, from about 10 nm to about 90 μm, from about 10 nm to about 80 μm, from about 10 nm to about 70 μm, from about 10 nm to about 60 μm, from about 10 nm to about 50 μm, from about 10 nm to about 40 μm, from about 10 nm to about 30 μm, from about 10 nm to about 20 μm, from about 10 nm to about 10 μm, from about 10 nm to about 9 μm, from about 10 nm to about 8 μm, from about 10 nm to about 7 μm, from about 10 nm to about 6 μm, from about 10 nm to about 5 μm, from about 10 nm to about 4 μm, from about 10 nm to about 3 μm, from about 10 nm to about 2 μm, from about 10 nm to about 1 μm, from about 10 nm to about 900 nm, from about 10 nm to about 800 nm, from about 10 nm to about 700 nm, from about nm to about 600 nm, from about 10 nm to about 500 nm, from about 10 nm to about 400 nm, from about 10 nm to about 300 nm, from about 10 nm to about 200 nm, from about 10 nm to about 100 nm, from about 25 nm to about 700 nm, from about 25 nm to about 600 nm, from about 25 nm to about 500 nm, from about 25 nm to about 400 nm, from about 50 nm to about 600 nm, from about 50 nm to about 600 nm, from about 75 nm to about 550 nm, from about 100 nm to about 500 nm, from about 10 nm to about 5 μm, from about 20 nm to about 5 μm, from about 30 nm to about 5 μm, from about 40 nm to about 5 μm, from about 50 nm to about 5 μm, from about 60 nm to about 5 μm, from about 70 nm to about 5 μm, from about 80 nm to about 5 μm, from about 90 nm to about 5 μm, from about 100 nm to about 5 μm, from about 200 nm to about 5 μm, from about 300 nm to about 5 μm, from about 400 nm to about 5 μm, from about 500 nm to about 5 μm, from about 600 nm to about 5 μm, from about 700 nm to about 5 μm, from about 800 nm to about 5 μm, from about 900 nm to about 5 μm, or from about 1 μm to about 5 μm.

In some embodiments, the polymeric shell can have a thickness of from about 1 nm to about 20 μm, from about 1 nm to about 15 μm, from about 1 nm to about 10 μm, from about 1 nm to about 5 μm, from about 1 nm to about 2 μm, from about 1 nm to about 1 μm, from about 1 nm to about 0.8 μm, from about 1 nm to about 0.75 μm, from about 1 nm to about 0.5 μm, from about 1 nm to about 0.25 μm, from about 1 nm to about 0.1 μm, from about 1 nm to about 90 nm, from about 1 nm to about 80 nm, from about 1 nm to about 70 nm, from about 1 nm to about 60 nm, from about 1 nm to about 50 nm, from about 1 nm to about 40 nm, from about 1 nm to about 30 nm, from about 1 nm to about 20 nm, from about 1 nm to about 10 nm, from about 1 nm to about 5 nm, from about 1 nm to about 15 nm, from about 1 nm to about 25 nm, from about 5 nm to about 50 nm, from about 5 nm to about 40 nm, from about 5 nm to about 30 nm, from about 5 nm to about 25 nm, from about 5 nm to about 20 nm, from about 10 nm to about 40 nm, from about 10 nm to about 30 nm, from about 10 nm to about 25 nm, or from about 10 nm to about 20 nm.

In some embodiments, the polymeric capsule can contain an acid solution within the inner chamber 32 of the capsule. In some embodiments, the acid solution can be a hydrochloric acid, nitric acid, or sulfuric acid solution. In some embodiments, the pH of the acid solution can range from about −1 to about 6.5, from about −1 to about 6, from about −1 to about 5.5, from about −1 to about 5, from about −1 to about 4.5, from about −1 to about 4, from about −1 to about 3.5, from about −1 to about 3, from about 1 to about 4, from about 1 to about 3, from about 1 to about 2, or from about 2 to about 4.

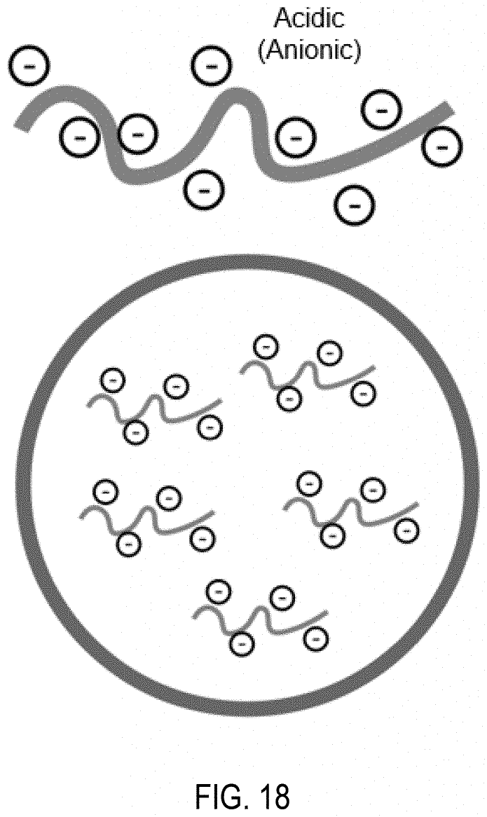

In some embodiments, the polymeric capsule can contain free polyacids within the inner chamber (see FIG. 18). In some embodiments, the solution includes one or more free polyacids, including, but not limited to poly(4-styrenesulfonic acid), poly(vinylsulfonic acid), poly(acrylic acid), and poly(methacrylic acid). Polyacid can behave similarly to a free acid by providing protons to drive uptake of target cation by the capsules. The benefit of using free polyacids in capsules is that there is a much lower permeability of polyacids through the capsule walls.

In some embodiments, the polymeric capsule can contain a strip solution within the inner chamber 32 of the capsule. Exemplary non-limiting strip solutions contained within the polymeric capsule can include pure water, acid solutions such as sulfuric acid and hydrochloric acid, and other solutions such as ammonia, ammonium hydroxide, ammonium carbonate, sodium hydroxide, and sodium bicarbonate. Strip solutions useful in solvent extraction methods are dependent on the target ions and the process being used, and can be readily determined by persons skilled in solvent extraction. Further exemplary strip solutions useful in solvent extraction can be found in Lo, T. C.; Baird, M. H. I.; Handson, C. Handbook of Solvent Extraction; Chapter 3B, Wiley: New York, 1983, incorporated herein by reference. In some embodiments, the polymeric capsule can contain a salt solution within the inner chamber 32 of the capsule. In some embodiments, the polymeric capsule can contain deionized water within the inner chamber 32 of the capsule. In some embodiments, the polymeric capsule can contain a solution having a high pH (e.g., a pH of from about 8 to about 14 or higher) within the inner chamber 32 of the capsule. For example, in some embodiments, the polymeric capsule can contain sodium hydroxide within the inner chamber 32 of the capsule.

In some embodiments, the polymeric capsule is a polymersome. Polymersomes, first developed in 1999 [11], are polymeric vesicles typically formed in aqueous solution via the self-assembly of amphiphilic block polymers (for example, polymers that contain discrete hydrophilic and hydrophobic segments or blocks), and have received tremendous interest in the fields of drug delivery, diagnostics, and controlled release [12]. The polymeric shell or vesicle membrane can contain a thin (e.g., 10-20 nm), dense nonpolar layer that is typically nearly impermeable to ions, formed by the hydrophobic block. In some embodiments, to enable metal transport, lipophilic metal carriers (e.g., ligands) can be dissolved within the nonpolar layer. In some embodiments, lipophilic ligands can be covalently bonded to the hydrophobic block of the amphiphilic block polymer. In such embodiments, upon formation of the polymersomes, the ligands can be sequestered within the nonpolar layer. Ligands that are dissolved, sequestered, or located within the polymeric shell or nonpolar layer can be partially or fully within the polymeric shell or nonpolar layer. In some embodiments, ligands dissolved, sequestered, or located within the polymeric shell or nonpolar layer can move freely back and forth between the exterior of the polymeric shell or nonpolar layer, where they complex one or more ions present outside the polymeric capsule and transport the complexed ions to the inner chamber 32 of the polymeric capsule, for example to a strip solution in the inner chamber 32.

A polymersome 40 according to one exemplary embodiment is shown in FIG. 4. The polymersome is assembled from an amphiphilic block polymer 45 having a hydrophilic block 46 and a hydrophobic block 47, to form polymeric shell 41 encasing inner chamber 42. In some embodiments, the polymersomes can be formed in a manner that allows a strip solution (e.g., an acid solution such as 1 M HCl, or other strip solution) to be entrapped in the aqueous interior of the polymersome such as in inner chamber 42. The nonpolar hydrophobic block forms a continuous barrier that (in the absence of ligand) is nearly impermeable to ions [13]. The polymersome further comprises lipophilic ligands 43 within the polymeric shell 41. In some embodiments, the polymeric shell 41 is crosslinked.

In some embodiments, polymersomes can have a diameter of from about 10 nm to about 20 μm, from about 10 nm to about 10 μm, from about 25 nm to about 700 nm, or from about 100 nm to about 500 nm. In some embodiments, at least one dimension of the polymersomes (e.g., diameter, length, width, etc.) can range from about 10 nm to about 20 μm, from about 10 nm to about 10 μm, from about 10 nm to about 9 μm, from about 10 nm to about 8 μm, from about 10 nm to about 7 μm, from about 10 nm to about 6 μm, from about 10 nm to about 5 μm, from about 10 nm to about 4 μm, from about 10 nm to about 3 μm, from about 10 nm to about 2 μm, from about 10 nm to about 1 μm, from about 10 nm to about 900 nm, from about 10 nm to about 800 nm, from about 10 nm to about 700 nm, from about 10 nm to about 600 nm, from about 10 nm to about 500 nm, from about 10 nm to about 400 nm, from about 10 nm to about 300 nm, from about 10 nm to about 200 nm, from about 10 nm to about 100 nm, from about 25 nm to about 700 nm, from about 25 nm to about 600 nm, from about 25 nm to about 500 nm, from about 25 nm to about 400 nm, from about 50 nm to about 600 nm, from about 50 nm to about 600 nm, from about 75 nm to about 550 nm, or from about 100 nm to about 500 nm.

In some embodiments, the nonpolar layer of the polymersomes can have a thickness of from about 1 nm to about 50 nm, from about 1 nm to about 40 nm, from about 1 nm to about 30 nm, from about 1 nm to about 20 nm, from about 1 nm to about 10 nm, from about 1 nm to about 5 nm, from about 1 nm to about 15 nm, from about 1 nm to about 25 nm, from about 5 nm to about 50 nm, from about 5 nm to about 40 nm, from about 5 nm to about 30 nm, from about 5 nm to about 25 nm, from about 5 nm to about 20 nm, from about 10 nm to about 40 nm, from about 10 nm to about 30 nm, from about 10 nm to about 25 nm, or from about 10 nm to about 20 nm.

In some embodiments, polymeric capsules such as polymersomes can be produced by forming a polymersome from at least one amphiphilic block polymer having a hydrophilic block and a hydrophobic block. Polymersomes may be prepared from a number of methods, including direct assembly from bulk polymer in water [11], [17], rehydration of a thin polymer film [13], and rapid mixing with water of polymer dissolved in organic solvent [20], [36]. In some embodiments, the polymersomes can be formed (e.g., by self-assembly) in a solution. In some embodiments, the polymersome can be formed in an acid solution. Non-limiting examples of acid solutions useful in some embodiments of the method of making a polymeric capsule by forming a polymersome include hydrochloric acid, nitric acid, or sulfuric acid solutions. In some embodiments, the acid solution can have a molarity ranging from about 0.1 M to about 5 M, from about 0.1 M to about 4.5 M, from about 0.1 M to about 4 M, from about 0.1 M to about 3.5 M, from about 0.1 M to about 3 M, from about 0.1 M to about 2.5 M, from about 0.1 M to about 2 M, from about 0.1 M to about 1.5 M, from about 0.1 M to about 1 M, from about 0.1 M to about 0.5 M, from about 1 M to about 5 M, from about 1 M to about 4 M, from about 1 M to about 3 M, from about 1 M to about 2 M, from about 2 M to about 5 M, from about 2.5 M to about 5 M, from about 3 M to about 5 M, from about 3.5 M to about 5 M, from about 4 M to about 5 M, or from about 4.5 M to about 5 M. In some embodiments, the acid solution can have a pH ranging from about −2 to about 6.5, from about −2 to about 6, from about −2 to about 5.5, from about −2 to about 5, from about −2 to about 4.5, from about −2 to about 4, from about −2 to about 3.5, from about −2 to about 3, from about −2 to about 2, from about −1 to about 1, from about −1 to about 4, from about −1 to about 3, from about −1 to about 2, from about 2 to about 4, or from about −0.5 to about 0.5.

In some embodiments, an optimal preparation technique can be determined for each block polymer type. In some embodiments, extrusion through membranes of defined pore sizes can be used to control the vesicle diameter by transforming larger vesicles into several smaller vesicles, thus reducing vesicle size[13], [20].

In some embodiments, the polymersome can be formed in a metal salt solution. Non-limiting examples of metal salt solutions include metal chlorides, such as MgCl₂, CaCl₂, NaCl, and KCl, and metal sulfates, such as MgSO₄, CaSO₄, Na₂SO₄, and K₂SO₄. In order to encapsulate a desired strip solution, such as an acid solution, polymersomes formed in metal salt solution can be buffer exchanged using a desalting column [13] to remove residual metal ions (e.g., Ca²⁺ in cases where the polymersome is formed in CaCl₂)). In some embodiments, after encapsulation of the desired strip solution, the lipophilic ligand can be added to the polymersome solution and allowed to dissolve into the polymersome walls. In some embodiments, the ligand can be directly dissolved during vesicle formation. However, it is believed that this may affect the aggregate morphology (i.e., vesicles or micelles). Micelles can be undesirable as they can have a hydrophobic central core and may not be able to encapsulate an aqueous (strip) solution.

In some embodiments, a lipophilic ligand can be added to the polymersome by exposing the polymersome to a solution comprising a lipophilic ligand. In some embodiments, the lipophilic ligand can be added to a polymersome formation solution. In some embodiments, the lipophilic ligand can be covalently bonded to the polymer that will form the polymersome.

In some embodiments, the polymersome can be formed directly in a strip solution, thus allowing direct encapsulation of the desired strip solution in the inner chamber of the polymersome. In some embodiments, the polymersome can be formed in any appropriate solution, which can later be exchanged, after formation of the polymersome, with a strip solution by exposing the formed polymersome to the desired strip solution. For example, in some embodiments wherein a polymersome is formed in a solution such as a metal salt solution, the method of making a polymeric capsule can further comprise exposing the formed polymersome to a strip solution such as an acid solution.

In some embodiments, the method of forming the polymersome can further comprise crosslinking the polymeric shell. In some embodiments, radical initiators can be used for crosslinking the polymeric shell. Exemplary non-limiting radical initiators include peroxides (e.g., benzoyl peroxide), azo-initiators, and redox initiators (e.g., persulfate/metabisulfite). In some embodiments, thiol-based crosslinkers can be used for crosslinking the polymeric shell. In some embodiments, after polymersomes of a desired size are formed, the hydrophobic block can be crosslinked using redox radical initiators or an aqueous photoinitiator [17]. In some embodiments, crosslinking can increase the stability and mechanical integrity of the polymersome or polymeric capsule. In some embodiments, such as where there is a large osmotic pressure difference (e.g., high salinity inside the vesicle and low salinity outside the vesicle), crosslinking can help prevent leakage of vesicle contents.

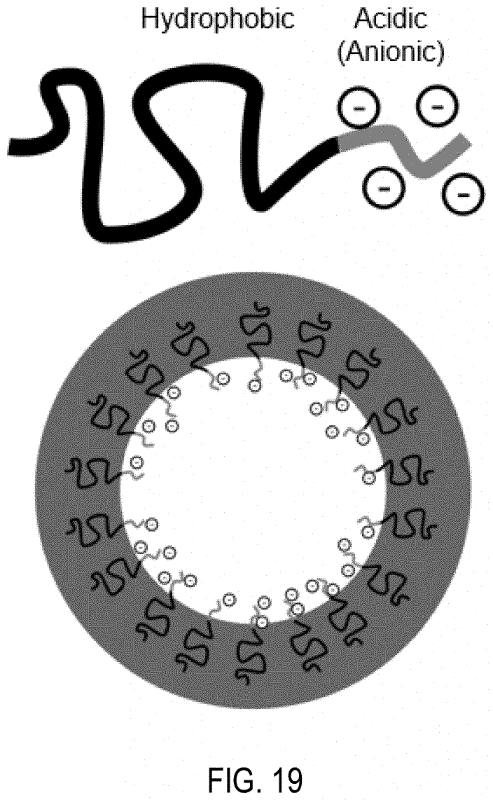

In some embodiments, the polymeric capsule is a microcapsule (see FIG. 19). Microcapsules are formed from evaporation of an organic solvent from a water-in-oil-in-water emulsion to form a hydrophobic polymer shell, which is typically stabilized by surfactants. As with polymersomes, microcapsules have a hydrophobic polymer wall that encapsulates an internal aqueous solution. Additionally, amphiphilic block polymers used to form polymersomes can be used as surfactants to stabilize microcapsules. Thus, many of the descriptions provided herein for polymersomes are also applicable for microcapsules with the exception that microcapsules generally have diameters ranging in micro-scale dimensions.

In some embodiments, microcapsules can have a diameter of from about 1 μm to about 1,000 μm, from about 10 μm to about 100 μm, from about 25 μm to about 700 μm, or from about 100 μm to about 500 μm. In some embodiments, at least one dimension of the microcapsules (e.g., diameter, length, width, etc.) can range from about 10 μm to about 100 μm, from about 1 μm to about 10 μm, from about 1 μm to about 9 μm, from about 10 μm to about 8 μm, from about 1 μm to about 7 μm, from about 1 μm to about 6 μm, from about 1 μm to about 5 μm, from about 1 μm to about 4 μm, from about 1 μm to about 3 μm, from about 1 μm to about 2 μm, from about 1 μm to about 10 μm, from about 10 μm to about 900 μm, from about 10 μm to about 800 μm, from about 10 μm to about 700 μm, from about 10 μm to about 600 μm, from about 10 μm to about 500 μm, from about 10 μm to about 400 μm, from about 10 μm to about 300 μm, from about 10 μm to about 200 μm, from about 10 μm to about 100 μm, from about 25 μm to about 700 μm, from about 25 μm to about 600 μm, from about 25 μm to about 500 μm, from about 25 μm to about 400 μm, from about 50 μm to about 600 μm, from about 50 μm to about 600 μm, from about 75 μm to about 550 μm, or from about 100 μm to about 500 μm.

In some embodiments, the polymeric capsule (e.g., microcapsule) includes a block copolymer that serves as a microcapsule stabilizer, also referred to as a polymeric surfactant (see FIG. 19). The block copolymer stabilizes the formation of the polymeric capsule, particularly helping to stabilize a water-in-oil emulsion. Removal of an organic solvent (e.g., evaporation) can create a polymeric microcapsule with internally facing polyacid blocks forming a brush layer and anchored hydrophobic polymer block. The diblock copolymer is shown at the top of FIG. 19, but other copolymer types (such as triblock, graft copolymers) could also be contemplated. The polyacid brush layer also provides acidity for ion exchange, similar to a free polyacid concept (see FIG. 18). In some embodiments, the polymeric capsule has an outer surface that includes a secondary stabilizer (e.g., polyvinyl alcohol).

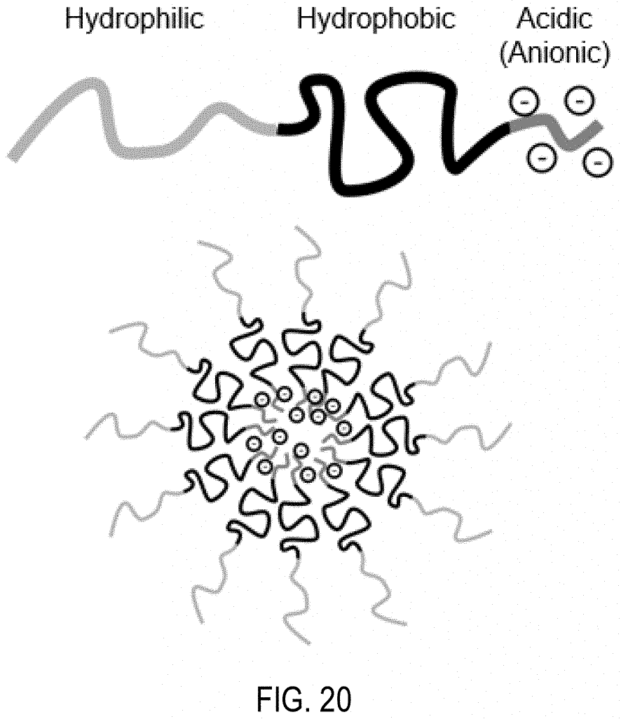

In some embodiments, the shell of the polymeric capsule includes a water-insoluble polymer and one or more surfactants. The one or more surfactants can include amphiphilic polymers provided herein. In some embodiments, the one or more surfactants comprise small molecules with a low hydrophilic-lipophilic balance (<8), such as sorbitan monooleate (e.g., commercially available as Span 80), sorbitan trioleate (e.g., commercially available as Span 85), or lecithin. In some embodiments, the surfactants are polymeric surfactants. The polymeric surfactants can include amphiphilic polymers. Exemplary polymeric surfactants have segments comprising polyvinyl alcohol, poly(ethylene oxide), poly(propylene oxide), poly(dimethyl siloxane), poly(butadiene), poly(isoprene), or poly(styrene). Exemplary polymeric surfactants have acidic segments, such as poly(4-styrene sulfonic acid), poly(acrylic acid), and poly(methacrylic acid). In some embodiments, the polymeric capsule includes a multi-block (e.g., tri-block copolymer) that forms polyacid-containing micelles (see FIG. 20). The multi-block copolymer can include a hydrophilic segment, a hydrophobic segment, and an acidic segment. The hydrophobic segment can form the barrier for selective ion transport. In some embodiments, the hydrophobic segment forms a water-insoluble shell. In some embodiments, the hydrophobic block can be crosslinked and/or be formed from glassy materials for morphology retention. The acidic segment is processed in form to allow it to self-assemble and face the inner chamber, meaning that the acidic segment is physically separated from the external aqueous solution by the hydrophobic segment. In some embodiments, this self-assembly is driven by using a hydrophobic polymer precursor (e.g., a polysulfonate-ester), after which a secondary reaction produces a hydrophilic polyacid (e.g., a polysulfonic acid). In some embodiments, the outer-facing hydrophilic block is neutrally charged.

In some embodiments of the polymeric capsules and methods described herein, the polymeric shell can comprise or be formed from one or more amphiphilic block polymers. In some embodiments, block polymers in metal selective capsules (e.g., polymersomes) are neutrally charged and non-interacting with ions. In some embodiments, block polymers in metal selective capsules (e.g., polymersomes) are highly stable. For example, in some embodiments, the block polymers in metal selective capsules can be more stable than liquid membrane extraction technology. In some embodiments, block polymers in metal selective capsules are crosslinkable to enhance stability. In some embodiments, the one or more amphiphilic block polymers can comprise a hydrophilic block that is uncharged, cationic, zwitterionic, or anionic. In some embodiments, the one or more amphiphilic block polymers can comprise a hydrophilic block that is uncharged, cationic, or zwitterionic. In some embodiments, uncharged, cationic, or zwitterionic hydrophilic blocks can provide high water solubility for the hydrophilic blocks of the polymers. In some embodiments, such as where a target species is an anion, the one or more amphiphilic block polymers can comprise a hydrophilic block that is anionic.

In some embodiments, the polymeric shell can comprise or be formed from a polymer with a glass transition temperature below 20° C. In some embodiments, where the glass transition temperature of the polymer is below 20° C., the polymeric capsule can exhibit high diffusivity of the ions during separation. In some embodiments, such as where the polymer is glassy or solid, e.g., where the glass transition temperature of the polymer is above 20° C., the polymeric capsule can exhibit decreased diffusivity of the ions during separation. In some embodiments, the polymeric shell comprises a polymer with a glass transition temperature above 20° C. and a plasticizer, which can, in some embodiments, allow the polymeric capsule to exhibit similar diffusivity as polymeric capsules comprising a polymer having a glass transition temperature below 20° C. In some embodiments, increasing glass transition temperature of the polymer, with or without the addition of plasticizer, can increase the stability of the polymeric capsule.

In some embodiments the one or more amphiphilic block polymers can comprise a hydrophilic block comprising a monomer selected from ethylene oxide, allyl alcohol, methyl oxazoline, acrylamide and derivatives thereof, zwitterionic derivatives of styrenic monomers and vinylpyridine, and cationic derivatives of styrenic monomers and vinylpyridine, and combinations thereof. In some embodiments, the hydrophilic block can comprise at least one of poly(ethylene oxide), poly(allyl alcohol), poly(methyl oxazoline), and poly(acrylic acid).

In some embodiments, the one or more amphiphilic block polymers can comprise a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof. In some embodiments, the hydrophobic block can comprise at least one of poly(butadiene), poly(styrene), poly(isoprene), and poly(dimethyl siloxane).

In some embodiments, the polymeric shell can comprise at least one polymer selected from poly(isoprene), poly(chloroprene), poly(butadiene), poly(myrcene), poly(farnesene), poly(citrenellol), hydrogenated poly(isoprene), hydrogenated poly(butadiene), polyethylene, polypropylene, polymers from styrenic derivatives, polymers from acrylic derivatives, polymers from acrylamide derivatives, polymers from siloxane derivatives, and polydimethylsiloxane.

In some embodiments, the polymeric shell can comprise poly(isoprene)-b-poly(allyl alcohol). A non-limiting example of synthesis of poly(isoprene)-b-poly(allyl alcohol) is provided according to Scheme I below:

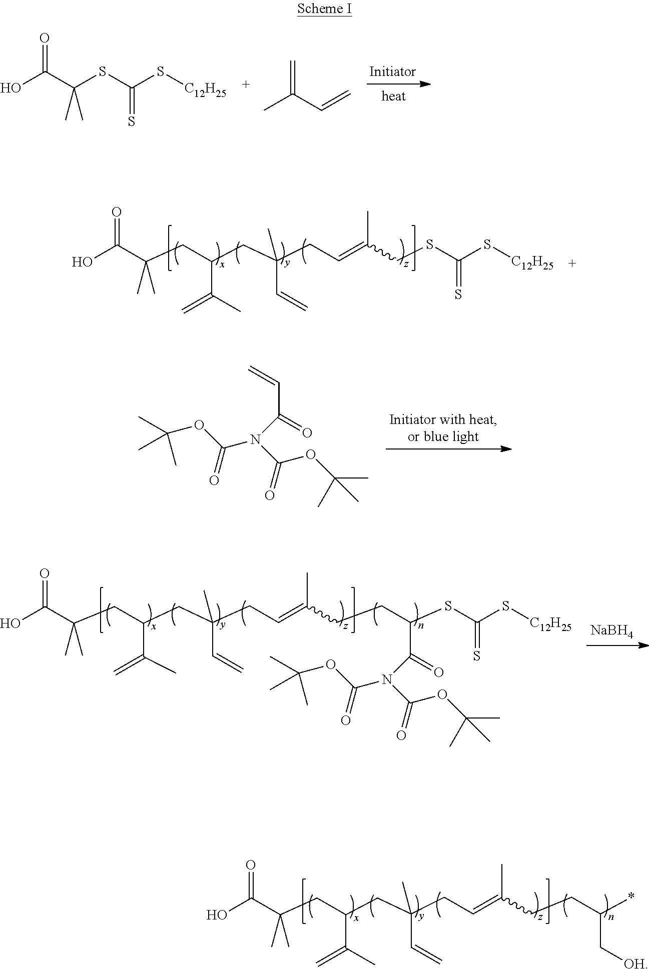

In Scheme I, 2-(dodecylthiocarbonotbioylthio)-2-methylpropionic acid (DDMAT) and isoprene are reacted in the presence of an initiator and heat. Non-limiting exemplary initiators useful in this process include azobisisobutyronitrile, tert-butyl peroxide, and cumyl peroxide. Next, di-boc acrylamide (DBAm) is added in the presence of an initiator and heat or blue light. Non-limiting exemplary initiators useful in this process include azobisisobutyronitrile. Polymerization procedures generally follow existing procedures [27]-[30]. Reduction [27], with a reducing agent such as NaBHI, and deprotection of poly(DBArn) will yield acid-stable, neutrally charged, hydrophilic polymer blocks linked to poly(isoprene), which has a low glass-transition temperature (Tg˜−61° C.) and is crosslinkable. In some embodiments, poly(allyl alcohol) is the primary target polymer. In some embodiments, poly(acrylamide) is a backup target polymer. 1,4 addition of isoprene is the dominant form (˜90%) [28], [29].

Synthesis of an alternative polymer, poly(isoprene)-b-poly(acrylamide), is provided according to Scheme II below:

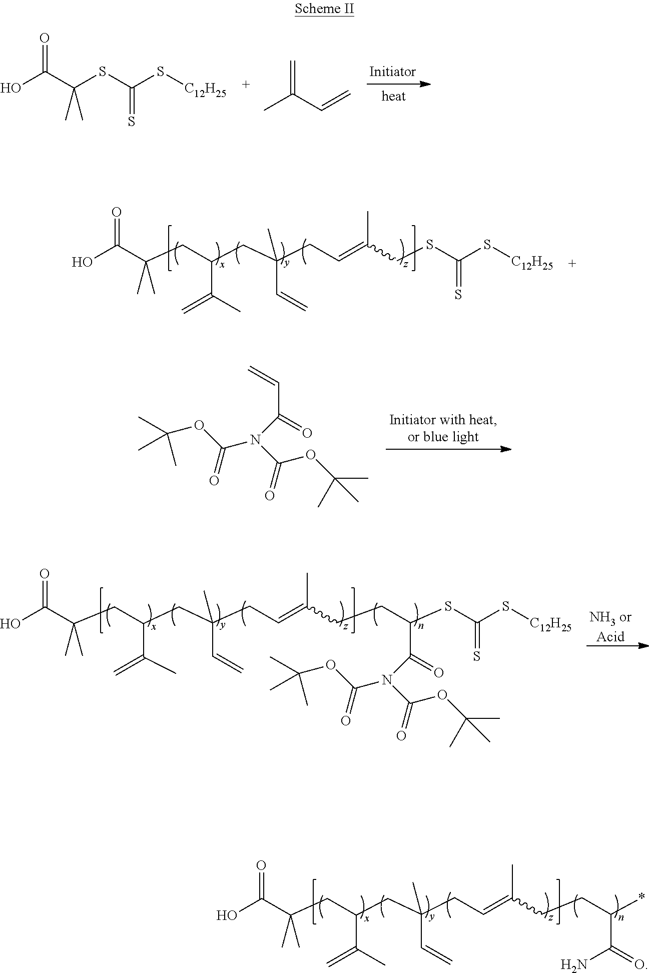

In some embodiments, the polymeric shell can comprise a polymer synthesized according to Scheme III:

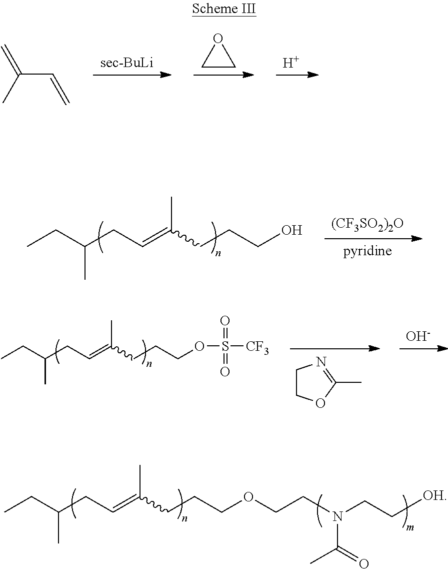

In some embodiments, the isoprene blocks in Scheme III can be replaced any of the following polymer blocks:

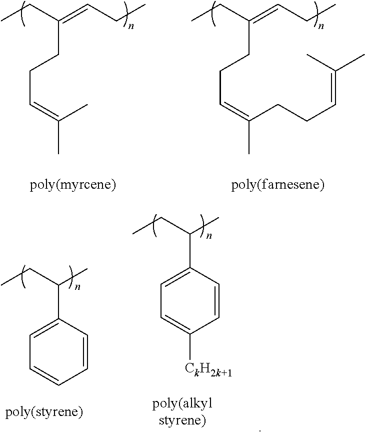

In some embodiments, the polymeric shell can comprise a polymer, poly(vinylbenzyltrimethylammonium chloride)-poly(isoprene) (PVB3MA-PI), synthesized according to Scheme IV:

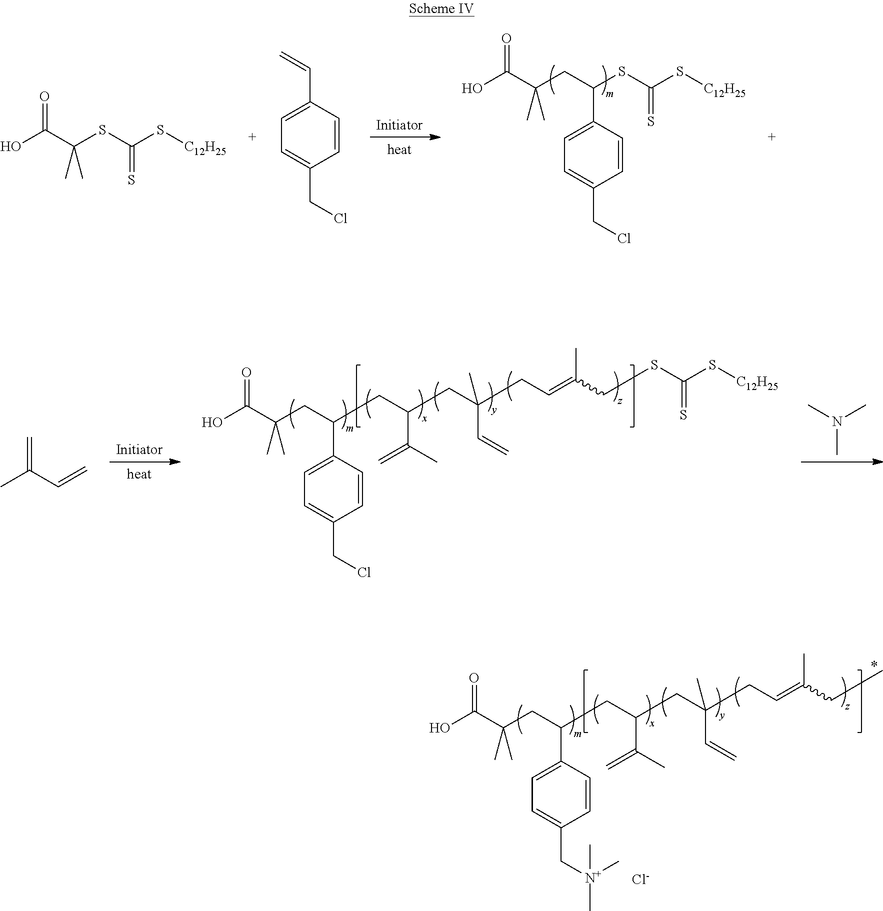

The polymeric capsules described herein can contain a lipophilic ligand within the polymeric shell. Any ligand that will dissolve in or covalently bond with the polymeric shell can be used. In some embodiments, the lipophilic ligand can be a freely diffusing ligand. In some embodiments, the lipophilic ligand can be a ligand that covalently bonds to the polymer of the polymeric shell. The specific ligand can be selected based on the desired target species for separation. For example, where the target species is a metal or metal ion, the lipophilic ligand can be a ligand that interacts with metal ions. In some embodiments, the ligand can specifically bind a target metal ion. In some embodiments, the lipophilic ligand can be selected from oximes, phosphoric acid derivatives, phosphinic acid derivatives, phosphonic acid derivatives, diketone derivatives, amine derivatives, ketone derivatives, polyether derivatives, crown ether derivatives, cryptand derivatives, calixarene derivatives, and combinations thereof.

In some embodiments, the lipophilic ligand can be di-(2-ethylhexyl)phosphoric acid (D2EHPA).

Also provided herein is a process for extracting target ions from a mixed solution. In some embodiments, the target ions are metal ions. The process can include exposing the mixed solution to polymeric capsules to produce a second solution. In some embodiments, the capsules can comprise a polymeric shell encasing an inner chamber and comprising an amphiphilic polymer having a hydrophobic block and a hydrophilic block; a lipophilic ligand within the polymeric shell; and a first strip solution (e.g., an acid solution) contained within the inner chamber of the capsule. In some embodiments, the capsules can comprise a polymeric shell encasing an inner chamber, with the shell comprising a hydrophobic polymer; a lipophilic ligand within the polymeric shell; and a first strip solution contained within the inner chamber of the capsule. In some embodiments, the capsule can be a polymersome. In some embodiments, the capsule can be a metal selective polymersome. In some embodiments, the lipophilic ligand can specifically bind the target metal ion, or other target ion. In some embodiments, the lipophilic ligand can bind a non-target ion in order to remove the non-target from the mixed solution.

In some embodiments, the method can further comprise removing the second solution from the capsules. In some embodiments, removing the second solution can comprise washing, e.g., washing the polymeric capsules, to remove non-target ions. In some embodiments, removing the second solution can comprise a size-based separation technique or a packed bed technique. Non-limiting exemplary separation techniques for removing the second solution can include membrane filtration, particle filtration using a packed bed, immobilization on particles within a packed bed, centrifugation, and the like. Non-limiting exemplary filtration techniques include filtration with one or more porous membranes and filtration using a packed bed of fine particles (e.g., sand). In some embodiments, the packed bed technique can comprise packing the capsules, clusters of the capsules, or capsules immobilized on granular supports within a column; and flowing aqueous solutions (e.g., the mixed solution, the second solution, or the like) through the column. In some embodiments, the method can further comprise exposing the capsules to a second strip solution (e.g., acid solution) to obtain a solution enriched in the target metal ion and regenerate the first strip solution within the capsules. In some embodiments, the method can further comprise collecting the target metal ions.

One exemplary embodiment of a method for extracting target ions from a mixed solution is shown in FIG. 5. In FIG. 5, a mixed solution is fed, as a metal-laden feed, into a reservoir containing polymeric capsules comprising a lipophilic ligand that binds the target ion. The target ion binds the lipophilic ligand and is transported into the strip solution inside the polymeric capsule. The non-target ions are then removed as raffinate through size-based filtration. In some embodiments, the process can operate as a near constant process with simultaneously feeding of new mixed solution and removal of raffinate. In some embodiments, one or more parts of the system can be involved in the process can be reversed. For example, in some embodiments, the lipophilic ligand can bind one or more non-target ions, thus allowing for sequestration of non-target ions inside the polymeric capsules and removal of a solution containing, as raffinate, one or more target metal ions.

### Exemplary Embodiment

Embodiment 1 is a capsule comprising a polymeric shell encasing an inner chamber; and a lipophilic ligand within the polymeric shell.

Embodiment 2 is the capsule of Embodiment 1, wherein the shell comprises one or more amphiphilic block polymers.

Embodiment 3 is the capsule of Embodiment 2, wherein the one or more amphiphilic block polymers comprises a hydrophilic block that is uncharged, cationic, zwitterionic, or anionic.

Embodiment 4 is the capsule of Embodiments 1-2, wherein the polymeric shell comprises a water-insoluble polymer with a glass transition temperature below 20° C.

Embodiment 5 is the capsule of Embodiments 1-2, wherein the polymeric shell comprises a plasticizer and a water-insoluble polymer with a glass transition temperature above 20° C.

Embodiment 6 is the capsule of Embodiments 1-4, wherein the capsule is a polymersome.

Embodiment 7 is the capsule of Embodiment 1, wherein the polymeric shell comprises at least one polymer selected from poly(isoprene), poly(chloroprene), poly(butadiene), poly(myrcene), poly(farnesene), poly(citrenellol), hydrogenated poly(isoprene), hydrogenated poly(butadiene), polyethylene, polypropylene, polymers from styrenic derivatives, polymers from acrylic derivatives, polymers from acrylamide derivatives, and polydimethylsiloxane.

Embodiment 8 is the capsule of Embodiment 2, wherein the one or more amphiphilic block polymers comprises a hydrophilic block comprising a monomer selected from ethylene oxide, allyl alcohol, methyl oxazoline, acrylamide and derivatives thereof, zwitterionic derivatives of styrenic monomers and vinylpyridine, and cationic derivatives of styrenic monomers and vinylpyridine, and combinations thereof.

Embodiment 9 is the capsule of Embodiment 8, wherein the hydrophilic block comprises at least one of poly(ethylene oxide), poly(allyl alcohol), poly(2-methyl-2-oxazoline), and poly(acrylamide).

Embodiment 10 is the capsule of Embodiments 2 or 8, wherein the one or more amphiphilic block polymers comprises a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof.

Embodiment 11 is the capsule of Embodiment 10, wherein the hydrophobic block comprises at least one of poly(butadiene), poly(styrene), poly(isoprene), and poly(dimethyl siloxane).

Embodiment 12 is the capsule of Embodiments 1-11, wherein the lipophilic ligand is selected from oxime derivatives, phosphoric acid derivatives, phosphinic acid derivatives, phosphonic acid derivatives, diketone derivatives, amine derivatives, ketone derivatives, polyether derivatives, crown ether derivatives, cryptand derivatives, calixarene derivatives, and combinations thereof.

Embodiment 13 is the capsule of Embodiments 1-12, further comprising a strip solution contained within the inner chamber of the capsule.

Embodiment 14 is the capsule of Embodiment 13 wherein the strip solution is an acid solution, and optionally, wherein the acid is hydrochloric acid, nitric acid, or sulfuric acid.

Embodiment 15 is the capsule of Embodiment 14, wherein the acid solution comprises a polymeric acid.

Embodiment 16 is the capsule of Embodiment 15, wherein the polymeric acid comprises a poly(styrene sulfonic acid), poly(acrylic acid), poly(methacrylic acid), or combinations thereof.

Embodiment 17 is the capsule of Embodiments 1-16, wherein at least one dimension of the capsule is from about 10 nm to about 5 mm.

Embodiment 18 is the capsule of Embodiment 17, wherein one dimension of the capsule is from about 10 nm to about 10 μm.

Embodiment 19 is the capsule of Embodiments 1-16, wherein the shell is from about 1 nm to about 20 μm thick.

Embodiment 20 is the capsule of Embodiment 17, wherein the shell is from about 1 nm to about nm thick.

Embodiment 21 is the capsule of Embodiments 1-18, wherein the lipophilic ligand interacts with metal ions.

Embodiment 22 is the capsule of any one of Embodiments 1-19, wherein the lipophilic ligand is a freely diffusing ligand.

Embodiment 23 is the capsule of any one of Embodiments 1-19, wherein the lipophilic ligand is covalently bonded to a polymer in the shell.

Embodiment 24 is the capsule of any one of Embodiments 1-21, wherein the shell is cross-linked.

Embodiment 25 is the capsule of Embodiment 1, wherein the shell comprises a water-insoluble polymer and one or more surfactants.

Embodiment 26 is the capsule of Embodiment 25, wherein the one or more surfactants comprise small molecules with a low hydrophilic-lipophilic balance (<8).

Embodiment 27 is the capsule of Embodiment 26, wherein the small-molecule surfactants comprise sorbitan monooleate, sorbitan trioleate, or lecithin.

Embodiment 28 is the capsule of any one of Embodiments 25-27, wherein the surfactants are polymeric surfactants.

Embodiment 29 is the capsule of any one of Embodiments 25-28, wherein the polymeric surfactants comprise amphiphilic polymers.

Embodiment 30 is the capsule of any one of Embodiments 25-29, wherein the polymeric surfactants have segments comprising polyvinyl alcohol, poly(ethylene oxide), poly(propylene oxide), poly(dimethyl siloxane), poly(butadiene), poly(isoprene), or poly(styrene).

Embodiment 31 is the capsule of any one of Embodiments 25-30, wherein the polymeric surfactants have acidic segments, such as poly(4-styrene sulfonic acid), poly(acrylic acid), and poly(methacrylic acid).

Embodiment 32 is the capsule of Embodiment 1, wherein the capsule comprises a multi-block copolymer.

Embodiment 33 is the capsule of Embodiment 32, wherein the multi-block copolymer comprises a hydrophilic segment, a hydrophobic segment, and an acidic segment.

Embodiment 34 is the capsule of Embodiment 33, wherein the hydrophobic segment forms a water-insoluble shell and the acidic segment faces the inner chamber.

Embodiment 35 is a method of making a polymeric capsule comprising:

forming, in a strip solution or a metal salt solution, a polymersome, from at least one amphiphilic block polymer having a hydrophobic block and a hydrophilic block; and
exposing the capsule to a solution comprising a lipophilic ligand.

Embodiment 36 is the method of any one of Embodiments 35 or 68-79, wherein the capsule is formed in a metal salt solution, and further comprising exposing the polymersome to a strip solution.

Embodiment 37 is the method of any one of Embodiments 35-36 or 68-73, wherein the one or more amphiphilic block polymers comprises a hydrophilic block comprising a monomer selected from ethylene oxide, allyl alcohol, methyl oxazoline, acrylamide and derivatives thereof, zwitterionic derivatives of styrenic monomers and vinylpyridine, and cationic derivatives of styrenic monomers and vinylpyridine, and combinations thereof.

Embodiment 38 is the method of Embodiment 35, wherein the hydrophilic block comprises at least one monomer selected from poly(ethylene oxide), poly(allyl alcohol), poly(2-methyl2-oxazoline), and poly(acrylamide).

Embodiment 39 is the method of any one of Embodiments 35-38 or 68-73, wherein the one or more amphiphilic block polymers comprises a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof.

Embodiment 40 is the method of Embodiment 39, wherein the hydrophobic block comprises at least one monomer selected from poly(butadiene), poly(styrene), poly(isoprene), and poly(dimethyl siloxane).

Embodiment 41 is the method of any one of Embodiments 35-40 or 68-73, wherein the lipophilic ligand is selected from oxime derivatives, phosphoric acid derivatives, phosphinic acid derivatives, phosphonic acid derivatives, diketone derivatives, amine derivatives, ketone derivatives, polyether derivatives, crown ether derivatives, cryptand derivatives, calixarene derivatives, and combinations thereof.

Embodiment 42 is the method of any one of Embodiments 35-36 or 69, wherein the strip solution is an acid solution, and optionally, wherein the acid solution comprises a hydrochloric acid, a nitric acid, a sulfuric acid solution, or combinations thereof.

Embodiment 43 is the method of any one of Embodiments 35-42 or 69-73, wherein the metal salt solution is MgCl2 or CaCl2).

Embodiment 44 is the method of any one of Embodiments 35-43 or 69-73, further comprising synthesizing the amphiphilic block polymer according to Scheme I, wherein Scheme I comprises:

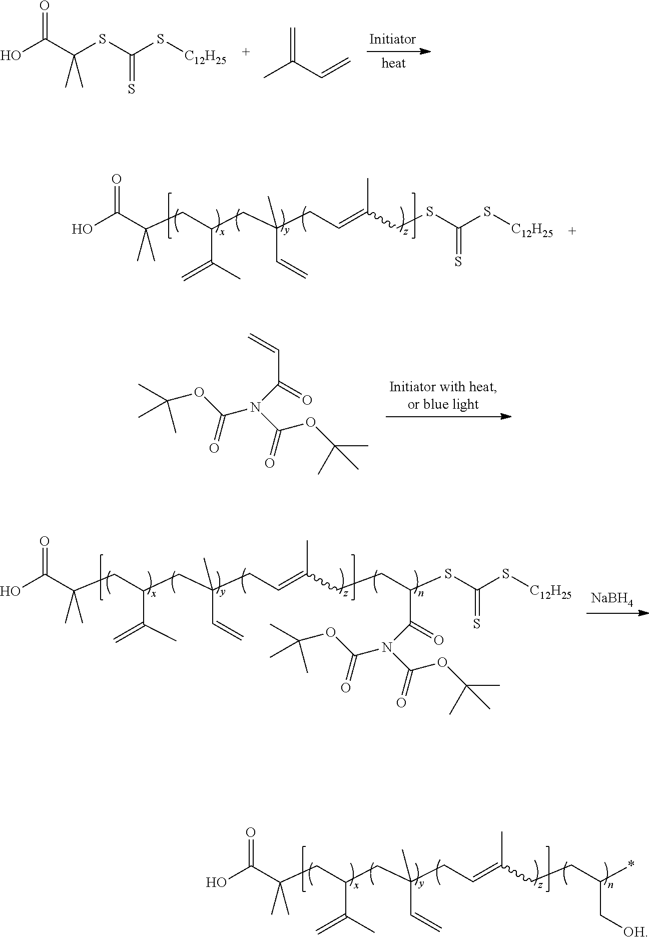

Embodiment 45 is the method of any one of Embodiments 35-43 or 69-73, further comprising synthesizing the amphiphilic block polymer according to Scheme II:

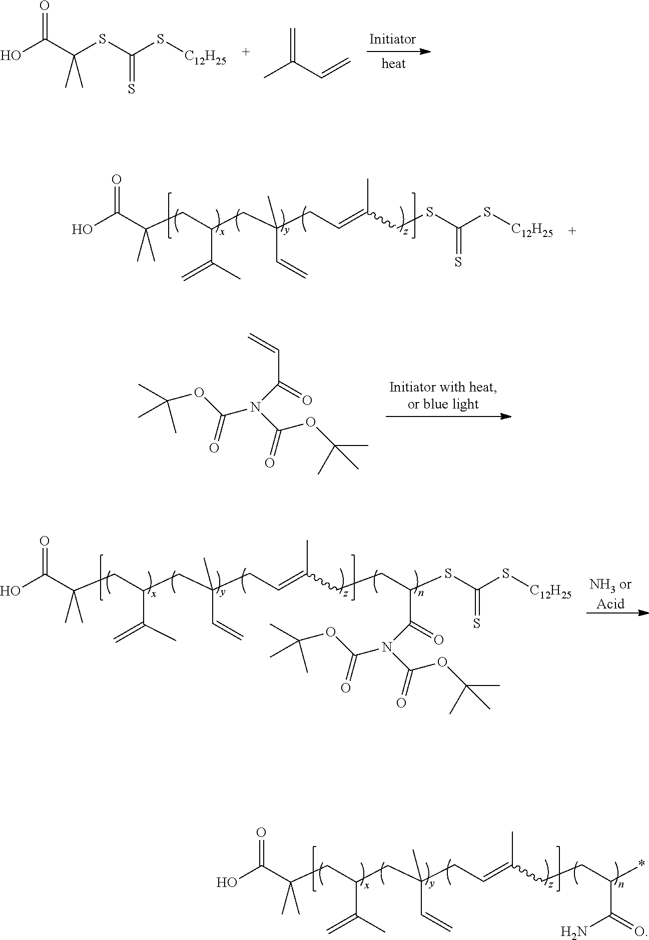

Embodiment 46 is the method of any one of Embodiments 35-43 or 69-73, further comprising synthesizing the amphiphilic block polymer according to Scheme III:

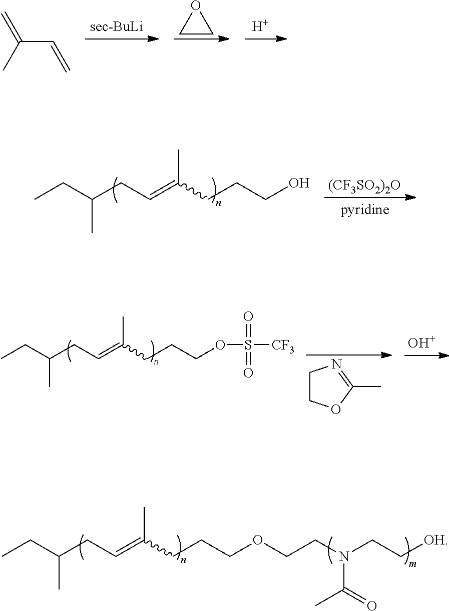

Embodiment 47 is the method of any one of Embodiments 35-43 or 69-73, further comprising synthesizing the amphiphilic block polymer according to Scheme IV:

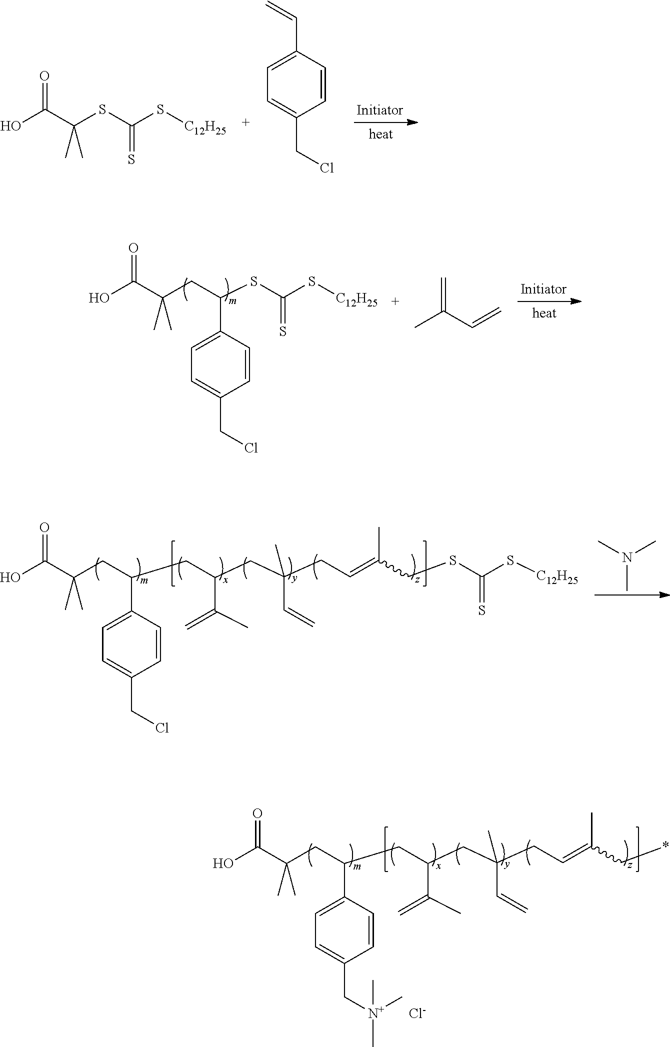

Embodiment 48 is a method of extracting target ions from a mixed solution comprising: exposing the mixed solution to polymeric capsules to produce a second solution, wherein the capsules comprise: a polymeric shell encasing an inner chamber; a lipophilic ligand within the polymeric shell; and a first strip solution contained within the inner chamber of the capsule.

Embodiment 49 is the method of any one of Embodiments 48 or 68-73, wherein the lipophilic ligand specifically binds the target ion.

Embodiment 50 is the method of any one of Embodiments 48-49 or 68-73, further comprising removing the second solution from the capsules.

Embodiment 51 is the method of any one of Embodiments 48-50, further comprising: exposing the capsules to a second strip solution to obtain a solution enriched in the target metal ion and regenerate the first strip solution within the capsules; and collecting the target ions.

Embodiment 52 is the method of any one of Embodiments 48-51, wherein removing the second solution comprises washing to remove non-target ions.

Embodiment 53 is the method of Embodiment 52, wherein removing non-target ions comprises a size-based separation technique or a packed bed technique.

Embodiment 54 is the method of Embodiment 53, wherein the size-based separation technique is filtration with porous membranes.

Embodiment 55 is the method of any one of Embodiments 48-54, wherein the shell comprises one or more amphiphilic block polymers, wherein the one or more amphiphilic block polymers comprises a hydrophilic block comprising a monomer selected from ethylene oxide, allyl alcohol, methyl oxazoline, acrylamide and its derivatives thereof, zwitterionic derivatives of styrenic monomers and vinylpyridine, and cationic derivatives of styrenic monomers and vinylpyridine, and combinations thereof.

Embodiment 56 is the method of Embodiment 55, wherein the hydrophilic block comprises at least one of poly(ethylene oxide), poly(allyl alcohol), poly(methyl oxazoline), and poly(acrylamide).

Embodiment 57 is the method of any one of Embodiments 55-56, wherein the one or more amphiphilic block polymers comprises a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof.

Embodiment 58 is the method of Embodiment 57, wherein the hydrophobic block comprises at least one of poly(butadiene), poly(styrene), poly(isoprene), and poly(dimethyl siloxane).

Embodiment 59 is the method of any one of Embodiments 48-58 or 68-73, wherein the lipophilic ligand is selected from oximes, phosphoric acid derivatives, phosphinic acid derivatives, phosphonic acid derivatives, diketone derivatives, amine derivatives, ketone derivatives, polyether derivatives, crown ether derivatives, cryptand derivatives, and calixarene derivatives.

Embodiment 60 is the method of any one of Embodiments 48-59 or 68-73, wherein the first strip solution, second strip solution, or combination thereof, is an acid solution, and optionally, wherein the acid is hydrochloric acid.

Embodiment 61 is the method of any one of Embodiments 48-60 or 68-73, wherein at least one dimension of the capsule is from about 10 nm to about 10 μm.

Embodiment 62 is the method of any one of Embodiments 48-61 or 68-73, wherein the shell is from about 1 nm to about 20 nm thick.

Embodiment 63 is the method of any one of Embodiments 48-62 or 68-73, wherein the lipophilic ligand is a freely diffusing ligand.

Embodiment 64 is the method of any one of Embodiments 48-63 or 68-73, wherein the lipophilic ligand is covalently bonded to a polymer in the shell.

Embodiment 65 is the method of any one of Embodiments 48-64 or 68-73, wherein the shell is cross-linked.

Embodiment 66 is the method of any one of Embodiments 48-65 or 68-73, wherein the extraction process is continuous or semi-continuous.

Embodiment 67 is the method of Embodiment 66, wherein removing non-target ions comprises a packed bed technique, and wherein the packed bed technique comprises:
packing the capsules, clusters of the capsules, or the capsules immobilized on granular supports within a column; and
flowing aqueous solutions through the column.

Embodiment 68 is a method of making a polymeric capsule comprising:
mixing, in a solvent, a lipophilic ligand with at least one amphiphilic block polymer having a hydrophobic block and a hydrophilic block;
evaporating the solvent to produce a ligand-polymer mixture;
adding an aqueous solution to the ligand-polymer mixture; and allowing the polymersomes to form.

Embodiment 69 is the method of Embodiment 68, wherein the aqueous solution is a strip solution or a metal salt solution.

Embodiment 70 is the method of any one of Embodiments 35 or 68-69, further comprising crosslinking the hydrophobic block of the polymer.

Embodiment 71 is the method of Embodiment 70, wherein the target ions are metal ions.

Embodiment 72 is the method of any one of Embodiments 1-34 or 48-67, wherein the polymeric shell comprises an amphiphilic polymer having a hydrophobic block and a hydrophilic block.

Embodiment 73 is the method of any one of Embodiments 1-34 or 48-67, wherein the polymeric shell comprises a hydrophobic polymer.

Embodiment 74 is a method of forming a polymeric capsule comprising:
forming a water-in-oil-in-water emulsion comprising an organic solvent; and
evaporating the organic solvent.

Embodiment 75 is a method of forming a polymeric capsule comprising:
forming a water-in-oil-in-water emulsion comprising an organic solvent and an oil phase, wherein the oil phase comprises a polymer and a lipophilic ligand; and
evaporating the organic solvent.

Embodiment 76 is a method of forming a polymeric capsule comprising:
forming a water-in-oil-in-water emulsion comprising an organic solvent;
adding a strip solution or a metal salt solution;
evaporating the organic solvent; and
allowing the capsules to form, wherein the capsules comprise:
   a polymeric shell encasing an inner chamber, and
   the strip solution or a metal salt solution contained within the inner chamber of the capsules.

Embodiment 77 is a method of forming a polymeric capsule comprising:
forming a water-in-oil-in-water emulsion comprising an oil phase, wherein the oil phase comprises a polymer and a lipophilic ligand; and
evaporating the organic solvent to form capsules.

Embodiment 78 is a method of forming a polymeric capsule comprising:
forming a water-in-oil-in-water emulsion comprising an organic solvent and an oil phase, wherein the oil phase comprises a surfactant; and
evaporating the organic solvent to form capsules.

Embodiment 79 is a method of forming a polymeric capsule comprising:
forming a water-in-oil-in-water emulsion comprising an organic solvent and an inner or outer aqueous phase, wherein the inner or outer aqueous phase comprises a surfactant; and
evaporating the organic solvent to form a capsule.

### EXAMPLES

Unless noted otherwise, all reagents were obtained from commercial suppliers. Unless noted otherwise, appropriate laboratory and analytical procedures were employed.

### Example 1: Modeling

Preliminary modeling was conducted to assess the expected performance of exemplary polymeric capsules such as metal selective polymersomes. Purely as an example, the models considered the extraction of cadmium ions (Cd²⁺) using the organophosphate ligand di-2-ethylhexylphosphoric acid (D2EHPA) [8]. This process involves cation exchange; during extraction each Cd²⁺ ion displaces two protons (H), which move into the aqueous phase. D2EHPA is a commonly used extractant in metal production (i.e., hydrometallurgy), typically exists as a dimer, and is well-characterized for the extraction of Cd²⁺ [8]. The results of this modeling, along with the underlying transport theory, illustrate the potential impact, expected characteristics, and practical requirements of exemplary metal selective polymersomes (MSPs).

### Facilitated Transport Membranes can Drastically Decrease the Required Amount of Ligand Compared to Solvent Extraction

In solvent extraction and facilitated transport membranes (including MSPs), the extraction and stripping of metal ions is governed by the reaction in Eqn. 1, shown for an aqueous divalent metal (M²⁺) [8].

M²⁺+n(RH)₂↔MR₂(n−1)(RH)₂+2H⁺ (Eqn. 1)

The forward reaction is extraction, while the reverse reaction is stripping. (RH)₂ is the dimerized ligand and MR₂(n−1)(RH)₂ is the metal-ligand complex that includes both deprotonated and protonated forms of the ligand. Both the dimerized ligand and the complex are always in the organic phase. n is the number of ligand dimers that are needed to complex the metal ion, which for the Cd²⁺/D2EHPA system is approximately 2.5 (i.e., 5 equivalents of ligand) [8]. In other words, two D2EHPA molecules become anionic, losing protons to balance the charge of the divalent cation, and three D2EHPA molecules add to the complex as neutral species.

It is generally expected that the conplexation reaction be at equilibrium at the water/organic interface [4]. The concentrations can therefore be compared as follows, assuming that all activity coefficients are 1:

$$K = \frac{{[ {MR}_{2} ( n - 1 ) {( RH )}_{2} ] [ {H}^{+} ]}^{2}}{{[ {M}^{2 +} ] [ {( RH )}_{2} ]}^{n}} \qquad ( Eqn . 2 )$$

K is the equilibrium coefficient. Rearranging allows determination of the ratio of complexed metal in the organic phase compared to free metal in the aqueous phase:

$$\frac{[ {MR}_{2} ( n - 1 ) {( RH )}_{2} ]}{[ {M}^{2 +} ]} \frac{{K [ {( RH )}_{2} ]}^{n}}{{[ {H}^{+} ]}^{2}} \qquad ( Eqn . 3 )$$

Eqn. 3 can be used to calculate the expected performance of a SX stage at equilibrium, based on the initial concentrations of metal and ligand, and the relative volumes of the aqueous and organic phases.

In MSPs and other facilitated transport membranes, the membrane can couple the extraction and stripping steps. Eqn. 2 applies to both interfaces:

$$K = \frac{{{[ {MR}_{2} ( n - 1 ) {( RH )}_{2} ]}_{F} [ {H}^{+} ]}_{F}^{2}}{{{[ {M}^{2 +} ]}_{F} [ {( RH )}_{2} ]}_{F}^{n}} = \frac{{{[ {MR}_{2} ( n - 1 ) {( RH )}_{2} ]}_{S} [ {H}^{+} ]}_{S}^{2}}{{{[ {M}^{2 +} ]}_{S} [ {( RH )}_{2} ]}_{S}^{n}} \qquad ( Eqn . 4 )$$

The subscripts “F” and “S” refer hereto the water/organic interfaces at the Feed solution and Strip solution, respectively. At equilibrium, the concentrations of free ligand and the metal/ligand complex are constant in the membrane, and the concentrations of aqueous metal and hydronium ions can be compared:

$$\frac{{[ {M}^{2 +} ]}_{F}}{{[ {M}^{2 +} ]}_{S}} = \frac{{[ {H}^{+} ]}_{F}^{2}}{{[ {H}^{+} ]}_{S}^{2}} \qquad ( Eqn . 5 )$$

Neglecting the relatively small amount of metal that is complexed within the membrane, the removal of a divalent metal cation is driven by the square of the proton gradient, which is mostly dependent on the pH of the strip solution. For example, if the equilibrium strip and feed pH are 1 and 3, respectively, the metal concentration is expected to be 10⁴-fold greater in the strip than in the feed.

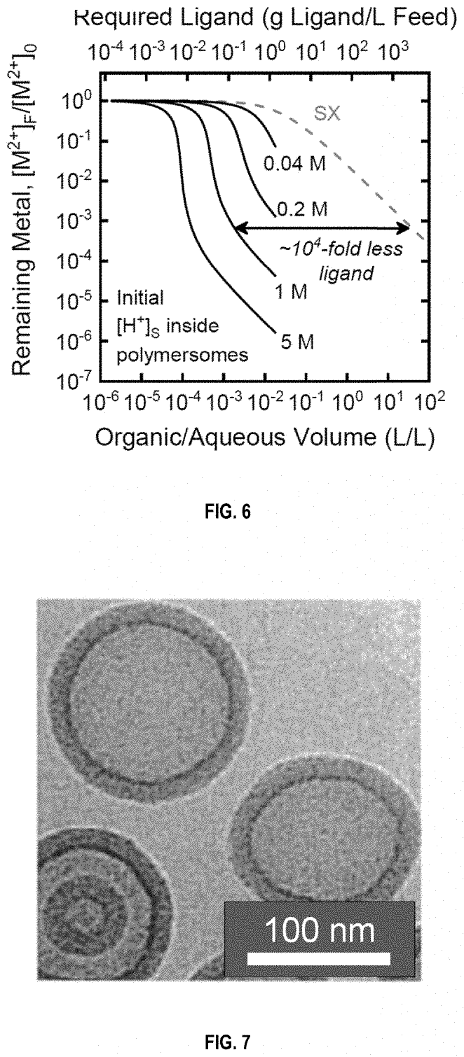

The effect of this coupling of the feed and strip solutions is shown in FIG. 6, in which the performance of MSPs and traditional SX are shown. FIG. 6 shows a decrease in metal concentration in the feed solution, [M²⁺]_{F} (starting as 100 ppm Cd²⁺) by SX and exemplary polymeric capsules (e.g., MSPs) when varying the initial pH of the strip solution inside the MSPs. Performance was modeled for 300-nm diameter MSPs with 10-nm nonpolar walls. MSP walls and SX organic phase were assumed to have the properties of 10 wt % D2EHPA in tetradecane [8]. MSP curves relate to the total volume of MSPs, with a maximum of 10% relative to the total volume.

Because the amount of metal removed with MSPs can depend on the strip solution pH and not the ligand concentration, about 10,000-fold less ligand can be required to remove a given amount of metal using MSPs with a starting strip solution of 1 M HCl than in traditional SX. This presents a key advantage of the polymeric capsules and methods described herein. Furthermore, this modeling considered a relatively high ligand concentration of 10 wt %. Decreasing the ligand concentration to 1 wt % would result in ˜10⁵-fold less required ligand in MSPs than in SX. The ligand concentration in MSPs is expected to mainly affect the kinetics.

The modeling also provides insight into the design requirements of MSPs. Because the amount of metal removed is related to the strip pH, MSPs should be able to tolerate very low pH levels (pH˜0). For example, for a feed of 100 ppm Cd²⁺, a strip solution of 0.04 M HCl (pH 1.4) would remove a maximum of 93 of the feed metal at 10% total vesicle volume, compared with 99.995% with a strip solution of 1 M HCl (see, e.g., FIG. 6). Conversely, a 5 M HCl strip solution would allow for ˜10-fold fewer MSPs (and ligand molecules) than for 1 M HCL Additionally, the strip solution pH determines the maximum concentration of metal that can be captured. For example, a starting strip solution of 1 M HCl has a theoretical maximum strip concentration of 0.5 M M²⁺, which is a relevant concentration for metal recovery. For this reason, encapsulation of concentrated acid solutions would allow for system volumes to be minimized and for recovered metal solutions to be relatively concentrated.

### Polymeric Vesicles Enable Ultra-Thin and Highly Stable Hydrophobic Barriers

Polymersomes were first developed as a fully synthetic, mechanically tough analog to lipid vesicles (or liposomes) [11]. Liposomes have been used in biochemistry for decades as model systems to study the properties of cell membranes [14] and have more recently been applied for use in drug delivery and diagnostics [15]. Polymersomes can enable a much broader range of properties than for lipids, as the chemical nature and polymer chain lengths can be independently tuned. The chain length is one basic difference, enabling the polymersome walls to reach 10-nm in thickness [16], as compared with the ˜4-nm thickness of lipid bilayers [14]. This enhanced thickness, even in the absence of crosslinking [17], can enable increased mechanical integrity [11]. The thickness of polymersome walls is still much thinner than the typical selective layer of industrial membranes (100-1000 nm) [9]. In terms of chemical structure, polymersomes have been formed from block polymers with rubbery and glassy hydrophobic blocks [18], [19]. Two of the most-studied block polymers with rubbery hydrophobic blocks—polymers with glass transition temperatures, Tg, below the operational temperature—are poly(ethylene oxide)-b-poly(1,2-butadiene) (PEO-PB; Tg,PB: −31° C.) and the ABA triblock polymer poly(2-methyl-2-oxazoline)-b-poly(dimethylsiloxane)-b-poly(2-methyl-2-oxazoline) (PMeOx-PDMS-PMeOx; Tg,PDMS: −123° C.) [13], [17], [20]. FIG. 7 shows exemplary cryo-electron microscopy images ofPEO-PB vesicles [16] that self-assembled in water with 15-nm thick walls and ˜100-nm diameters. Poly(styrene) (Tg: 100° C.) has been used as a glassy hydrophobic block, often with poly(acrylic acid) or PEO as the hydrophilic block [18], [19]. In all of these examples, the hydrophilic block is solvated by water molecules, whereas the hydrophobic (nonpolar) block forms a dense layer with largely the same properties as a thin slab of the corresponding homopolymer (e.g., PB homopolymer).

Molecular transport through the walls of liposomes and polymersomes typically follows the solution-diffusion model [13], [14], which is widely used for membrane transport [9], [21]. In this model, solutes dissolve from the aqueous phase into the membrane, diffuse across the membrane thickness, and desorb into the opposite aqueous phase. Transport in the solution-diffusion model is diffusive in nature, meaning that molecules move down their concentration gradients inside the membrane [9]:

$$J = - D \frac{d c}{dx} = \frac{D}{δ} ( {c}_{m , 0} - {c}_{m , δ} ) \qquad ( Eqn . 6 )$$

Here, J is the solute flux in the x-direction, D is the solute diffusivity within the membrane, c is the concentration of solute, c_{m,0} and c_{m,δ} are the solute concentrations within the membrane at x=0 and x=δ, respectively, and δ is the thickness of the membrane. For passive diffusive transport, a partition or sorption coefficient, Kₛ, can be included that relates the solute concentration in the membrane to that in the aqueous phase (i.e., Kₛ=c_{m,x}/cₓ). Incorporating Kₛ into Eqn. 6 yields

$$J = \frac{{K}_{s} D}{δ} ( {c}_{0} - {c}_{δ} ) = P ( {c}_{0} - {c}_{δ} ) \qquad ( Eqn . 7 )$$

where P is the diffusive permeability.

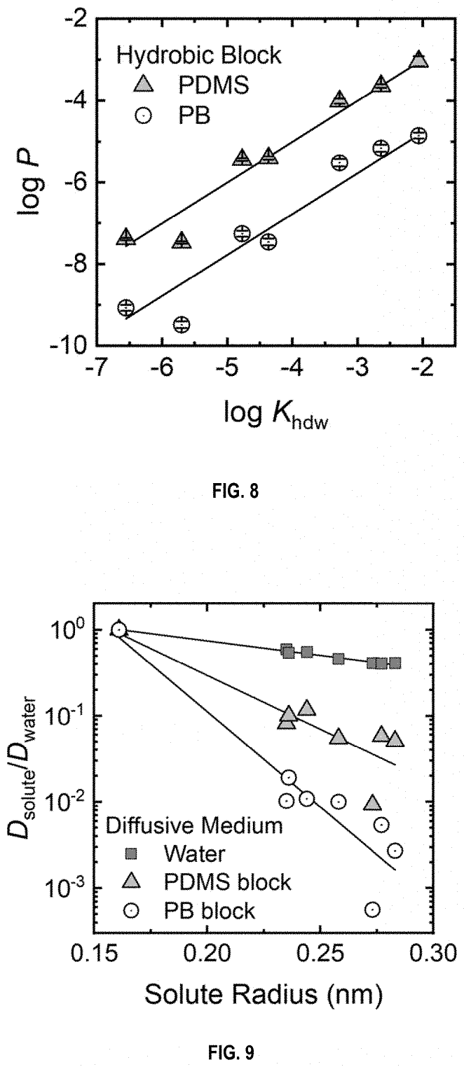

The permeability of PEO-PB and PMeOx-PDMS-PMeOx polymersomes was recently analyzed using the solution-diffusion model (Eqn. 7). Following similar work on liposomes [22], permeation behavior was analyzed by modeling the block polymer bilayer as a homogeneous slab of nonpolar phase, in other words, assuming that permeation was entirely dictated by the hydrophobic domain [13]. To test this model, the permeability of neutral organic solutes of varying polarity were compared with their hexadecane/water partition coefficients (K_{hdw}), as shown in FIG. 8. [13] A strong correlation was found over six orders of magnitude between log P and log K_{hdw} with a slope of 1, suggesting that P∝K_{hdw}. In other words, the walls of polymersomes can be approximately modeled as defect-free, homogeneous slabs of nonpolar phase. Furthermore, the partitioning into the nonpolar phase was the dominant component of permeability, although the diffusivities estimated from the permeabilities did show a weak size-dependence (FIG. 9).[13] The size-dependence was greatest for PB, which had the highest Tg, as compared to PDMS.

In terms of ion transport, the dense, defect-free nonpolar phase results in extremely low ion permeability in the absence of an ion carrier or ion channel. In the study on polymersomes mentioned above [13], sodium (Na⁺) permeability was measured by entrapping 300 mM NaCl inside the polymersomes, buffer exchanging into an isosmotic MgCl₂/MgSO₄ solution, then measuring the extravesicular Na⁺ concentration over time. Over the course of 6 days, just ˜2% of the Na⁺ permeated the walls of the PEO-PB and PMeOx-PDMS-PMeOx polymersomes, corresponding to permeabilities of ˜10⁻¹⁵ m/s [13]. This extremely low permeability stems from the high Born solvation energies (˜57 kcal/mol) [15], [23] needed to bring ions from water (ε=78) into a medium of low dielectric constant such as a hydrocarbon or nonpolar phase (P=2.0 for dodecane).

Fast Extraction Kinetics of MSPs Will Depend on the Diffusivity and Carrier Concentration

Modeling was used to assess the expected performance of MSPs, this time looking at kinetics. In facilitated transport membranes, the flux of metal is diffusive in nature (similar to Eqn. 6), only in this case sorption is dependent on multiple factors (Eqn. 3) and the diffusing species is a metal/ligand complex. The flux can be written as [4]:

$$J = \frac{D}{δ} ( {[ {MR}_{2} ( n - 1 ) {( RH )}_{2} ]}_{x = 0} - {[ {MR}_{2} ( n - 1 ) {( RH )}_{2} ]}_{x = δ} ) \qquad ( Eqn . 8 )$$

Flux can also be related to the overall metal concentration in the feed [M²⁺]_{F}, via mass balance:

$$J = \frac{- {V}_{F}}{{A}_{P}} \frac{{d [ {M}^{2 +} ]}_{F}}{dt} = \frac{- {r}_{P} {V}_{F}}{3 {V}_{P}} \frac{{d [ {M}^{2 +} ]}_{F}}{d t} \qquad ( Eqn . 9 )$$

V_{F} is the volume of the feed solution. Aₚ and Vₚ are the cumulative area and volume of MSPs, respectively. rₚ is the radius of the MSPs, which are assumed in the models to be monodisperse.

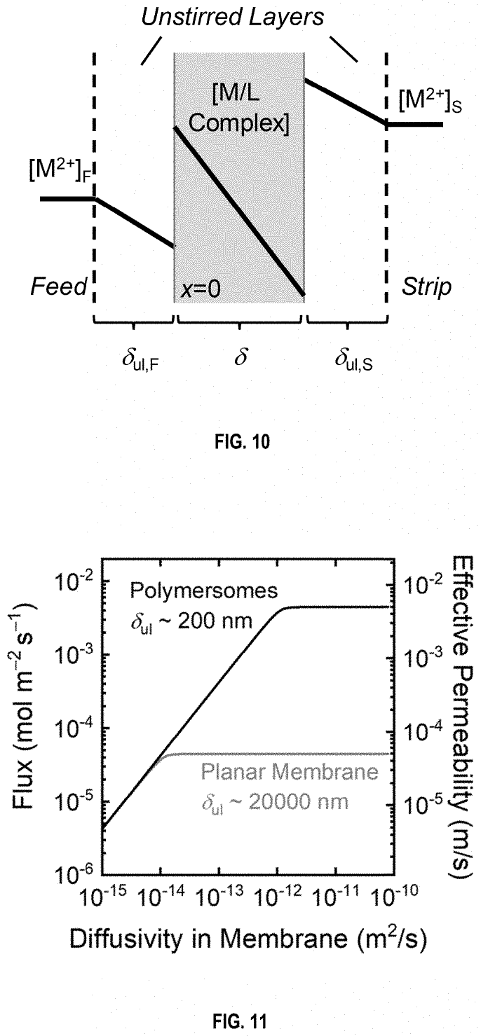

With respect to the impact of mass transfer limitations in the aqueous phase, incomplete mixing leads to boundary layers near the membrane surface, in which concentration gradients form due to the need for metal to diffuse to or from the surface. This phenomenon, termed concentration polarization, is typically modeled using film theory, in which the boundary layer is assumed to be a stagnant (unstirred) layer of thickness cui, as illustrated in FIG. 10 [4], [9]. In practice, the feed channel for planar membranes incorporates a spacer to both define the channel height and to enhance mixing. Even with this enhanced mixing, unstirred layers can typically be >20 μm in thickness [24], [25]. For MSPs, the unstirred layer thicknesses must be estimated using geometric arguments. For the strip solution, the maximum unstirred layer thickness is simply the internal radius of the polymersome. For the feed solution, an unstirred layer thickness can be estimated based on Vₚ and rₚ. For rₚ of 100-150 nm and Vₚ of 0.01-0.1, δᵤₗ is approximately 200 nm, as detailed in the Boundary Layer Thickness section below.

The effect of boundary layers on flux is shown in FIG. 11, as modeled for a 10-nm thick membrane with 10% D2EHPA. For planar systems with this membrane, mass transfer limitations in the aqueous phase become the dominant resistance at relatively low metal/ligand complex diffusivities of ˜10⁻¹⁴ m²/s. For MSPs, the sharply lower unstirred-layer thicknesses allow for ˜100-fold greater fluxes and effective permeabilities, with boundary-layer resistance only affecting performance above ˜10⁻¹² m²/s. This decreased boundary-layer resistance not only affects productivity (flux), but also the selectivity of the system. For a system with two or more metals, if boundary layers become the dominant resistance, then the boundary layer—not the membrane—determines the flux of each species, eliminating the selectivity of the membrane [4]. For MSPs, the effects of boundary layers are expected to be minimal, which would allow for the intrinsic selectivity and permeability of the system to be fully realized. Such lack of boundary layers has been observed experimentally for polymersomes mixed with solutions of relatively permeable organic solutes (e.g., butyric acid), which rapidly permeated the polymersome walls and reached equilibrium in <0.1 s [13].

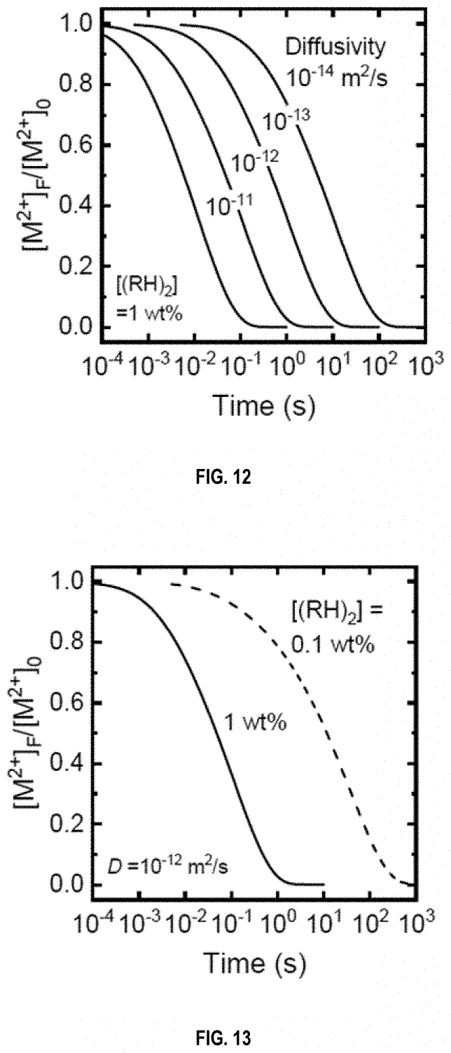

With respect to estimating the kinetics of metal removal using MSPs, the modeling described herein assumed that the interfacial reactions are fast, meaning that local equilibrium is obtained, as has been observed in other facilitated transport membrane systems [4], [10]. Considering the ultra-thin thickness of the walls of MSPs, this assumption should be further tested experimentally. Under the assumption of interfacial equilibrium, metal removal was assessed for diffusivities within the membrane varying from 10⁻¹¹ to 10⁻¹⁴ m²/s for 1 wt % D2EHPA (FIG. 12). For this diffusivity range, >99% of the metal is expected to be removed within 100 s, with the length of time being proportional to D (i.e., 10-fold lower D leads to 10-fold longer removal times). Such behavior can be expected from Eqn. 8 and the negligible effect of boundary layers. It can be difficult to project, without experimental evidence, what the diffusivities of metal/ligand complexes will be in MSP systems. Diffusivities in supported liquid membrane systems range from 2×10⁻¹¹ to 6×10⁻¹⁰ m²/s [4]. Polymeric facilitated transport membranes, which have mostly been glassy polymer films with added plasticizer to increase polymer chain mobility, have had diffusivities of ˜10⁻¹² m²/s [10]. Small molecule diffusivity in rubbery polymers (e.g., benzene in natural rubber) are typically ˜10⁻¹¹ m²/s [26]. Based on the above values for analogous systems, diffusivities will likely be ˜10⁻¹² m²/s, with ˜10⁻¹³ m²/s serving as a conservative estimate. Regardless, near-complete removal of the target metal is expected for systems with residence times of less than 2 minutes, which would allow for rapid, scalable processing.

Based on Eqn. 3, the ligand concentration helps determine the concentration of the metal/ligand complex, which affects the flux in Eqn. 8. As such, the ligand concentration may be tuned in MSPs to yield the desired kinetics while ensuring efficient use of possibly expensive ligands. Kinetics for D2EHPA concentrations of 1 wt % and 0.1 wt % are shown in FIG. 13. For the Cd²⁺-D2EHPA system, the number of dimers that complex each ion (n in Eqn. 1) is 2.5, which factors into Eqn. 3. A 10-fold decrease in the initial ligand concentration leads to a ˜10^{2.5}-fold (˜300-fold) increase in the time of metal removal.

### Selectivity Using MSPs in a Single Stage Will be Similar to Ideal Solvent Extraction

In some applications of extractive separations, the main goal may be the maximum removal of similarly binding metals, such as the removal and concentration of actinides in nuclear waste [4]. However, in most applications, success can be contingent on high selectivity between similar ions that are hard to separate by other methods (e.g., based on charge or size). As discussed earlier, the facilitated transport process in MSPs is extractive in nature. Selectivity is therefore similar in MSPs to the corresponding SX system. Because MSPs should experience minimal concentration polarization, the selectivity at any given point can be identical to solvent extraction at the same conditions (i.e., metal concentrations and pH) [4]. Metal/ligand complex diffusivities will likely be similar among different metals. Therefore, as in SX, the main driving force for selectivity can be the equilibrium coefficient (Eqn. 2), which is determined by the binding affinity of the ligands for the particular metal.

One large difference between SX and MSPs is that while SX reaches equilibrium in each stage, MSPs must be used in a non-equilibrium fashion for highly effective separations. Because of the pH gradient between the feed and strip solutions, the full equilibrium for a multi-component system would generally (at long times) be to remove the majority of all metals in solution. A key difference is their rate of removal or the relative flux, J₁/J₂, which is the measure of instantaneous selectivity of the system and, again, can be identical to an SX process at the corresponding conditions. The cumulative process selectivity at time t, (t), can be defined as the ratio of the normalized amount of removed metal:

$$β ( t ) = \frac{( {[ {M}_{1}^{2 +} ]}_{0} - [ {M}_{1}^{2 +} ] ( t ) ) / {[ {M}_{1}^{2 +} ]}_{0}}{( {[ {M}_{2}^{2 +} ]}_{0} - [ {M}_{2}^{2 +} ] ( t ) ) / {[ {M}_{2}^{2 +} ]}_{0}} \qquad ( Eqn . 10 )$$

where M₁²⁺ is the target metal for removal, M₂²⁺ is a non-target divalent metal, [M²⁺](t) is the metal concentration in the feed solution at time t, and [M²⁺]₀ is the initial metal concentration in the feed solution.

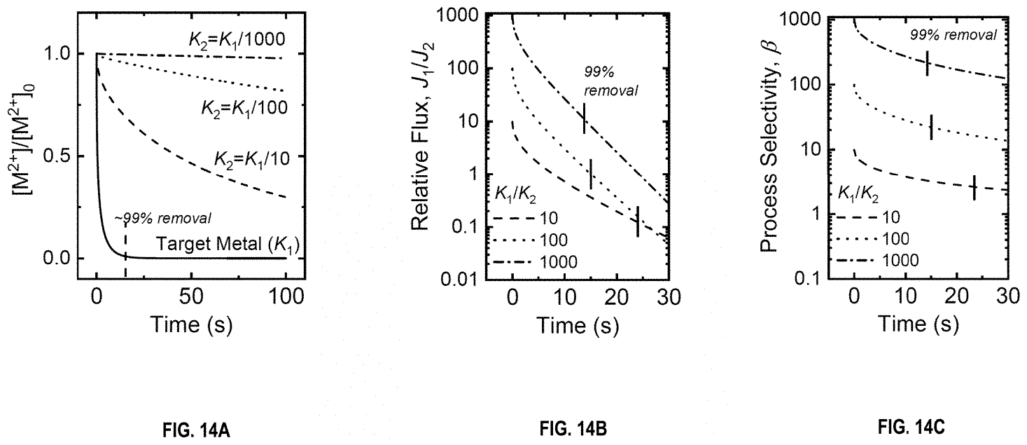

The modeled separation of metals by MSPs based on their K values is shown in FIG. 14A. These kinetic traces show that rapid and effective separations are possible based solely on ligand-metal binding affinity. Processes may need to be operated such that the residence time—the amount of time that the feed solution is in contact with the MSPs during the extraction step—can be controlled to minimize permeation of the non-target species (M₂²⁺). Initially, the relative flux for a solution with equal concentrations of M₁²⁺ and M₂²⁺ is simply K₁/K₂. As the target species is removed, the decreased concentration decreases the driving force, thereby decreasing the flux, J₁. The selectivity, as given by relative flux, decreases below 1 within 30 s for the three conditions modeled (FIG. 1B). If the extraction is allowed to continue, the overall selectivity, β, can continue to decrease, even though the bulk of the target metal has already been removed (FIG. 14C). In situations where the target metal is highly toxic and near-complete removal is desired, such decreases in selectivity may be acceptable. In other situations, controlling the residence time (to 15-25 s in the modeled cases) can allow for ˜99% removal of the target metal and an overall selectivity of ˜0.2K₁/K₂. Such single-stage performance is competitive with multi-stage SX. Additionally, given the expected dramatic reduction in ligand requirements for MSPs (FIG. 6), it is possible that more selective ligands can be used for routine applications, increasing K₁/K₂ and therefore allowing for improved process selectivities.

### Boundary Layer Thicknesses for MSP Systems

For MSPs, unstirred layer thicknesses can be estimated by geometric approximations. For the strip solution, the maximum thickness is simply the internal radius of the polymersome. For the feed solution, it is first assumed that a system with n polymersomes of radius r is equally distributed such that the MSPs are arranged in a hexagonal close-packed (HCP) arrangement. Each polymersome is then at the center of a theoretical sphere of radius r_{hcp}, where these theoretical spheres are close-packed. Assuming no mixing occurs in the system, the unstirred layer thickness becomes

δᵤₗ=r_{hcp}−r (Eqn. A1)

The total normalized volume occupied by spheres in an HCP system is π/(3✓2), or ˜0.74. Therefore, the volume of each sphere, V_{hcp} is

$${V}_{hcp} = \frac{π}{3 \sqrt{2}} \frac{1}{n} \qquad ( Eqn . A2 )$$

It is simpler to work with the total (outer) volume of polymersomes, Vₚ, which is equal to

$${V}_{P} = nV = \frac{4 n π {r}_{p}^{3}}{3} \qquad ( Eqn . A3 )$$

where V is the volume of an individual polymersome. Substituting this in for n results in

$${V}_{hcp} = \frac{π}{3 \sqrt{2}} \frac{4 π {r}_{p}^{3}}{3 {V}_{p}} = \frac{2 {π}^{2} \sqrt{2}}{9} \frac{{r}_{p}^{3}}{{V}_{p}} \qquad ( Eqn . A4 )$$

From Eqn. A4, r_{hcp} can be solved for:

$${r}_{hcp} = {( \frac{3 {V}_{hcp}}{4 π} )}^{1 / 3} = {( \frac{π \sqrt{2}}{6 {V}_{p}} )}^{1 / 3} {r}_{p} \qquad ( Eqn . A5 )$$

Finally, plugging Eqn. A5 into Eqn. A1 results in:

$${δ}_{ul} = {r}_{p} [ {( \frac{π \sqrt{2}}{6 {V}_{p}} )}^{1 / 3} - 1 ] \qquad ( Eqn . A6 )$$

For a Vₚ of 0.01, meaning 1% of the total system, δᵤₗ=2.74rₚ. For a Vₚ of 0.1, δᵤₗ=0.73rₚ. Based on a polymersome radius of 100-150 nm, δᵤₗ can be estimated as ˜200 nm.

### Modeling Methodology and Assumptions

All modeling was completed in Python 3.6 (Python Software Foundation) with the NumPy and SciPy add-ons, using the Scientific Python Development Environment (Spyder Project Contributors). As discussed above, models considered the equilibrium extraction data established for the Cd²⁺/D2EHPA system in tetradecane [8]. Specifically, this data establishes in Eqn. 2 the equilibrium coefficient, K, as 0.0258 and the number of ligand dimers that complex each metal ion, n, as 2.5 (i.e., 5 ligand monomers per metal ion) [8]. All concentrations were taken as molarity, with the wt % of D2EHPA converted to molarity using the density of tetradecane (0.764 g/mL). Other important parameters—such as the MSP wall thickness and diameter, ligand concentration, initial feed concentration, and starting pH levels—are specified in the discussion of the relevant figures.

The general approach was to numerically find the roots of relevant equations (specifically, Eqns. 3, 5, 8 and 9) using built-in solvers in Python, specifically brentq for single nonlinear functions and fsolve for multivariate systems of nonlinear functions. The brentq function requires that bounds be specified, which were established given the parameters of the system. For example, if solving for the amount of ligand that was complexed, bounds were set at 0 and the concentration equivalent to all of the ligand being complexed. The fsolve function is sensitive to the initial guess, which were established by first solving for simpler situations (e.g., no concentration polarization).

The equilibrium models in FIGS. 1, 2A-2B, and 6 were relatively simple. FIG. 1 was generated by solving for the metal/ligand complex concentration, [ML], from Eqn. 3 (where the notation for [ML] is [MR₂(n−1)(RH)₂]). [M²⁺]_{F} and the free ligand concentration, [L], are determined by mass balance from

$$\begin{matrix}{[ {M}^{2 +} ]}_{F} = {[ {M}^{2 +} ]}_{0} - \frac{{V}_{o}}{{V}_{F}} [ ML ] & ( Eqn . A7 ) \\ {L}_{T} = n [ ML ] + [ L ] & ( Eqn . A 8 )\end{matrix}$$

L_{T} is the total ligand concentration. In Eqn. 3, [L] is given as [(RH)₂]. The subscript 0 in Eqn. A7 refers to the initial condition. Eqns. A7, A8, and 3 were combined in order to determine [ML] and, subsequently, [M²⁺]_{F}. For the solvent extraction curve in FIG. 6, Eqn. 3 was again solved, this time additionally including a mass balance for H⁺:

$${[ {H}^{+} ]}_{F} = {[ {H}^{+} ]}_{0} + \frac{2 {V}_{o}}{{V}_{F}} [ ML ] \qquad ( Eqn . A9 )$$

For equilibrium with MSPs (FIG. 6), the mass balances must also include the strip solution:

$$\begin{matrix}{[ {M}^{2 +} ]}_{F} = {[ {M}^{2 +} ]}_{0} - \frac{{V}_{o}}{{V}_{F}} [ ML ] - {\frac{{V}_{S}}{{V}_{F}} [ {M}^{2 +} ]}_{S} & ( Eqn . A10 ) \\ {[ {H}^{+} ]}_{F} = {[ {H}^{+} ]}_{F , 0} + \frac{2 {V}_{o}}{{V}_{F}} [ ML ] + {\frac{2 {V}_{S}}{{V}_{F}} [ {M}^{2 +} ]}_{S} & ( Eqn . A 11 ) \\ {[ {H}^{+} ]}_{S} = {[ {H}^{+} ]}_{S , 0} - {2 [ {M}^{2 +} ]}_{S} & ( Eqn . A 12 )\end{matrix}$$

Eqns. A10-A12 were inserted into Eqns. 3 and 5 to solve for [ML] and [M²⁺]ₛ, which were then used to solve for the rest of the concentrations.

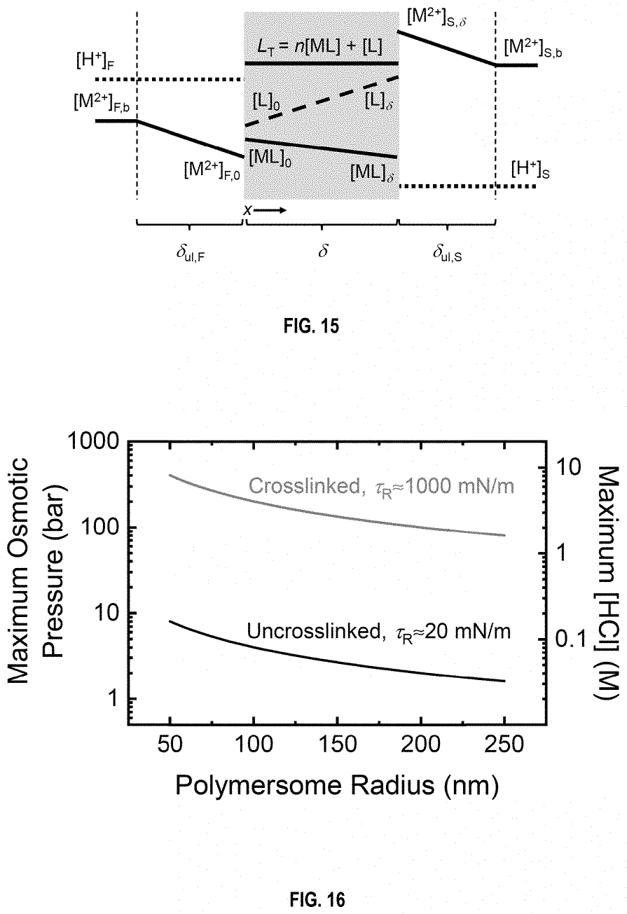

For kinetic models (FIGS. 12-14), Euler's method was used to iteratively solve for the relevant concentrations with time. Fluxes were found to decrease substantially with time. For this reason, 3000 iterations were used at non-constant time intervals, with the first 2000 timepoints covering the first 10 of the total time, and the second 1000 timepoints covering the last 99%. To simplify modeling, concentration polarization of protons was neglected, which is acceptable given the high diffusivity of H⁺ and the potential existence of buffering species such as carbonate in real systems, which would help to replace H⁺ concentrations at the interface [13]. The total ligand concentration, LT, was assumed to be constant at any point within the membrane, meaning that Eqn. A8 applied at any point x in the membrane. Concentration polarization was included for the metal(s), using a diffusivity, DM, of 10-m²/s. Concentration polarization was found to be negligible in the strip solution (i.e., [M²⁺]ₛ,δ:[M²⁺]_{S.b}) and was only significant in the feed solution in the initial stages when fluxes were at their highest. The concentrations that were modeled with time were therefore [M²⁺+]_{F,b}, [M²⁺]_{F,0}, [M²⁺]_{S},δ, [M²⁺]_{S,b}, [H⁺]_{F}, [H⁺]_{S}, [ML]₀, and [ML]δ, as depicted in FIG. 15. Here the subscript 0 refers to the position x=0, which is the feed/membrane interface.

Iterations started with initial conditions for the bulk concentrations of M²⁺ and H⁺. Three fluxes of metal occur simultaneously, one in the feed solution (J_{F}), one within the membrane (Jₘ), and one within the strip solution (J_{S}):

$$\begin{matrix}{J}_{F} = \frac{{D}_{M}}{{δ}_{ul , F}} ( {[ {M}^{2 +} ]}_{F , b} - {[ {M}^{2 +} ]}_{F , 0} ) & ( Eqn . A13 ) \\ {J}_{m} = \frac{{D}_{ML}}{δ} ( {[ ML ]}_{0} - {[ ML ]}_{δ} ) & ( Eqn . A 14 ) \\ {J}_{S} = \frac{{D}_{M}}{{δ}_{ul , S}} ( {[ {M}^{2 +} ]}_{S , δ} - {[ {M}^{2 +} ]}_{S , b} ) & ( Eqn . A 15 )\end{matrix}$$

Eqn. A14 is equivalent to Eqn. 8 in the main text. D_{ML} is the diffusivity of the metal/ligand complex within the membrane, given as D in Eqn. 8. The fluxes should all be identical, yielding the root equations 0=J_{F}−Jₘ and 0=J_{S}−Jₘ. Simultaneously solving these two equations, plus Eqn. 3 at both interfaces, allows for determination of the interface concentrations [M²⁺]_{F,0}, [M²⁺]s,δ, [ML]₀, and [ML]δ. When two metals were considered, concentration polarization in the strip solution was ignored, resulting in only one root flux equation (0=J_{F}−Jₘ) for each metal, which are combined with four equations describing the interfacial reactions for a total of six equations. These were solved simultaneously to yield values for [M₁²⁺]_{F,0}, [M₁L]₀, [M₁L]δ, [M₂²⁺]_{F,0}, [M₂L]₀, and [M₂L]δ. After solving for the interfacial concentrations, the fluxes and bulk concentrations could be determined. Fluxes were calculated from Eqns. A13-A15 and compared to ensure equality. Bulk concentrations for the next iteration (j+1) were then calculated from the flux at iteration j:

$$\begin{matrix}{[ {M}^{2 +} ]}_{F , b} ( j + 1 ) = {[ {M}^{2 +} ]}_{F , b} ( j ) - \frac{{J}_{m} ( j ) {A}_{P}}{{V}_{F}} ( t ( j + 1 ) - t ( j ) ) & ( Eqn . A16 ) \\ {[ {M}^{2 +} ]}_{S , b} ( j + 1 ) = {[ {M}^{2 +} ]}_{S , b} ( j ) + \frac{{J}_{m} ( j ) {A}_{P}}{{V}_{S}} ( t ( j + 1 ) - t ( j ) ) & ( Eqn . A 17 ) \\ {[ {H}^{+} ]}_{F} ( j + 1 ) = {[ {H}^{+} ]}_{F} ( j ) + \frac{2 {J}_{m} ( j ) {A}_{P}}{{V}_{F}} ( t ( j + 1 ) - t ( j ) ) & ( Eqn . A 18 ) \\ {[ {H}^{+} ]}_{S} ( j + 1 ) = {[ {H}^{+} ]}_{S} ( j ) - \frac{2 {J}_{m} ( j ) {A}_{P}}{{V}_{A}} ( t ( j + 1 ) - t ( j ) ) & ( Eqn . A 19 )\end{matrix}$$

Aₚ is again the total area of MSPs, which is related to the (outer) volume of MSPs (Vₚ), and the radius. V_{S} is the total strip volume, which is the total inner volume of MSPs. V_{F} is the aqueous feed solution volume. Eqns. A16-A19 include mass balances accounting for the volumes of the system. Iterating using this procedure enabled the kinetic modeling shown in FIGS. 12, 13, and 14A-14C. For the consideration of boundary layers and membrane configuration in FIG. 11, the procedure was very similar to that of the kinetic models for a one-metal system. The main difference was that only the initial flux was considered, as determined using the starting concentrations.

### Example 2: Synthesis of Neutral Amphiphilic Block Polymers and MSPs as Crosslinked Polymersomes with Lipophilic Carriers

Poly(isoprene)-b-poly(allyl alcohol) is chosen as a synthetic target. Poly(isoprene) is an aliphatic, crosslinkable polymer with a low Tg (−61° C.). Poly(allyl alcohol) is water-soluble and stable at low and high pH [27], and will likely be much more inert towards cations than PEO. Importantly, it can be produced via the mild reduction of a newly developed polymer: poly(di-boc acrylamide) or poly(DBAn) [27]. This allows the block polymer to first be made using poly(DBAm), which is soluble in most organic solvents, then reduced to form poly(allyl alcohol), which is soluble in water and polar organic solvents. Both poly(isoprene) and poly(DBAm) have been synthesized using reversible addition-fragmentation chain transfer (RAFT) polymerizatin, a class of controlled radical polymerization, using the same chain transfer agent [27]-[30]. The proposed synthetic scheme (Scheme I) builds on these established reactions to form the block polymer.

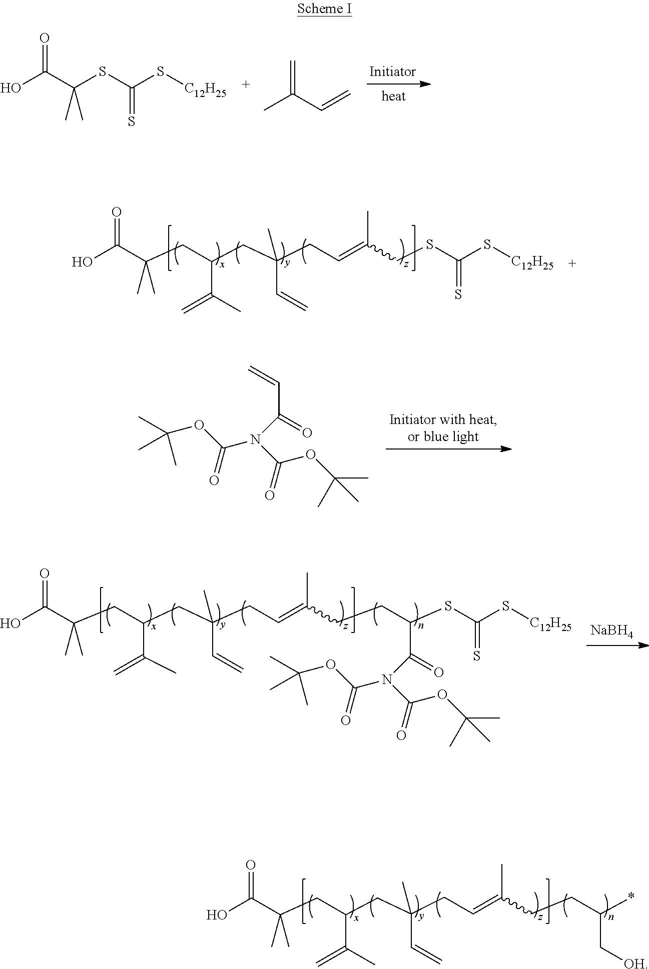

In Scheme I, 2-(dodecylthiocarbonothioylthio)-2-methylpropiolic acid (DDMAT) and isoprene are reacted in the presence of an initiator and heat. Next, di-boc acrylamide (DBAm) is added in the presence of an initiator and heat or blue light. Polymerization procedures generally follow existing procedures [27]-[30]. Reduction [27], with NaBH₄, and deprotection of poly(DBAm) will yield acid-stable, neutrally charged, hydrophilic polymer blocks linked to poly(isoprene).

For analysis of the effects of polymer chemistry on the performance of MSPs, other block polymers such as poly(isoprene)-b-poly(acrylamide) are synthesized. Poly(isoprene)-b-poly(acrylamide) is synthesized according to Scheme II below:

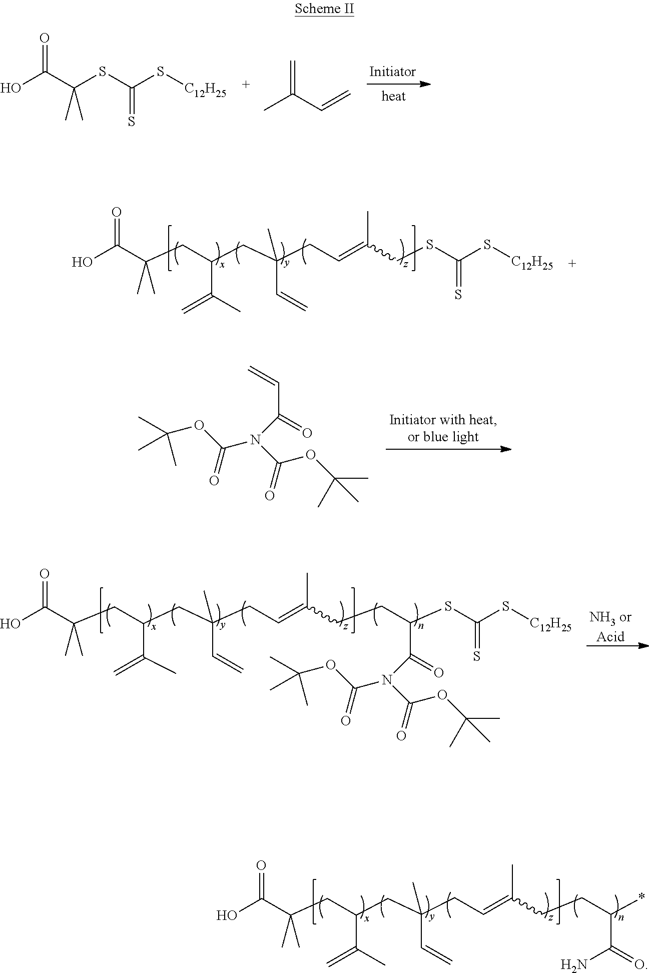

Poly(isoprene)-b-poly(acrylamide) can be formed from the same poly(isoprene)-b-poly(DBAm) precursor by removing the boc protecting groups using acid or ammonia (Scheme II). Scheme III shows an alternative synthetic scheme to form poly(isoprene)-b-poly(2-methyl-2-oxazoline) using anionic polymerization of isoprene [31] followed by cationic ring opening polymerization of 2-methyl-2-oxazoline [20].

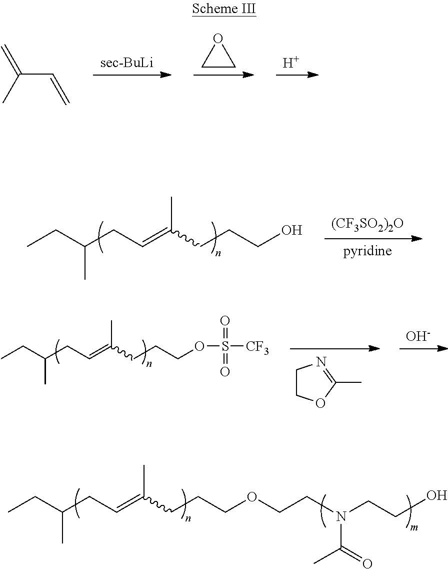

Several alternative hydrophobic blocks for replacing the isoprene blocks in Scheme III are shown below, all of which can be produced through RAFT or anionic polymerization [32]-[35]:

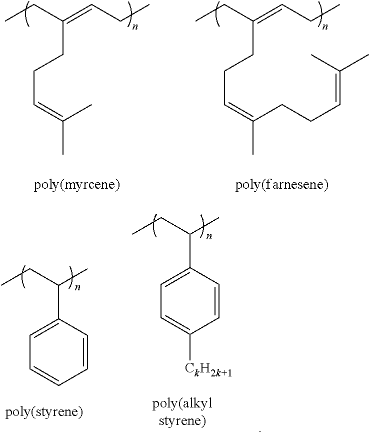

These potential chemistries vary in a few important characteristics, including polarity and Tg, that could affect properties like ligand efficacy and diffusivity. Myrcene and farnesene are dimers and trimers, respectively, of isoprene. Poly(myrcene) and poly(farnesene) similarly have low glass transition temperatures of −40 and −75° C., respectively [32] [34]. Poly(styrene) will serve as a contrasting chemistry as it is glassy (Tg˜100° C.) and aromatic. Poly(alkylstyrene) allows for control of Tg based on the alkyl chain length [35]. The purity, chemical structure, and chain length of synthesized polymers are characterized using nuclear magnetic resonance (NM) spectroscopy, infrared spectroscopy, and size exclusion chromatography.

Di-(2-ethylhexyl)phosphoric acid (D2EHPA) will be used as the model ligand for initial MSP demonstrations. After ligand dissolution, HCl (e.g., 1 M HCl) will be added to exchange H⁺ for Ca²⁺, essentially stripping Ca²⁺ from the MSPs. Other metal salts besides CaCl₂ could also be used, or ideally polymersomes could be formed directly in ICI solutions. Buffer exchanging again into deionized water will yield ligand-bearing MSPs loaded with strip solution.

### Example 3: Assessment of Stability of MSPs in Extreme Environments

The metal extraction process with MSPs will place the polymersomes in relatively extreme environments in terms of pH, ligand concentration, and osmotic pressure differences. Polymersomes used as a matrix for MSPs will need to be tested for chemical and physical stability at extreme pH levels (pH<0 and >14) and at elevated temperature, as elevated temperatures (e.g., 50° C.) [37] are sometimes used in SX to increase selectivity. Chemical stability is assessed using NMR and infrared spectroscopies. Physical stability is assessed by measuring the leakage of encapsulated ions (e.g., sodium) using an ion selective electrode or ion chromatography [13]. The ligands used, as well as any potential co-dissolved phase modifiers, are surfactant-like and could affect the self-assembly properties of polymersomes, even possibly causing the polymers to dissolve or adopt an alternative aggregate morphology, such as micelles [38]. The aggregate morphology of uncrosslinked and crosslinked polymersomes with increasing concentration of ligand is assessed using dynamic light scattering (DLS) and cryo-electron microscopy (cryo-EM).

The osmotic pressure differences will stem from the desire to have a concentrated strip solution (1-5 M HCl) within the MSPs, whereas the feed solution with the target metal could vary widely in composition and osmolarity. The osmotic pressure difference, A7, can be approximated using the van't Hoff equation [9], [21]:

Δp=Δπ≈(nₛcₙ−n_{F}c_{F})RT (Eqn. 11)

Here, n is the number of ions per molecule (e.g., 2 for HCl), R is the gas constant, and T is the absolute temperature. Subscripts again refer to the feed and strip solutions. Δπ will cause swelling of the polymersomes by water influx to decrease the osmotic gradient. Polymersomes cannot swell indefinitely, and a pressure, Δp, will build within the vesicle. The maximum pressure, Δp max, that the polymersomes can withstand is defined by the Laplace equation [39]:

$$Δ {p}_{max} = \frac{2 {τ}_{R}}{{r}_{P}} \qquad ( Eqn . 12 )$$

where τ_{R} is the rupture tension and rₚ is the polymersome radius. Rupture tension data is relatively limited for polymersomes. The most relevant study assessed the rupture tension of uncrosslinked and crosslinked PEO-PB vesicles, finding values of 20 and 1000 mN/m, respectively [17]. Inserting these values into Eqn. 12 yields FIG. 16, showing that pressures in excess of 100 bar may be tolerated for crosslinked systems, whereas uncrosslinked polymersomes would rupture at <10 bar. This translates to 2-8 M HCl, depending on the polymersome radius. Based on this data, crosslinking appears to strongly participate in stability of MSPs. Osmotic rupture is studied by measuring leakage of encapsulated sodium ions at increasing osmotic pressure gradient, brought about by dilution of the surrounding solution. Results will be compared with the extent of crosslinking, polymer chain length, wall thickness, and the size of the vesicles.

### Example 4: Characterization of Kinetics and Efficacy of Single Metal Removal Using Lab-Scale Setup

The organophosphate ligand D2EHPA is used for proof-of-principle evaluation of MSPs. D2EHPA has been found to extract divalent metals in the order Zn²⁺>Ca²⁺>Mn²⁺>Cu²⁺>Co²⁺>Ni²⁺>Mg²⁺, with the pH at which 50% of the metal is extracted varying from 1.5-4.5 [40]. This order can change depending on experimental conditions, such as the solvent used and the presence of any phase modifiers (i.e., cosolvents) [40]. The extraction of Cu²⁺ is characterized, with the concentration of Cu²⁺ being quantified by ion chromatography, inductively coupled plasma mass spectrometry (ICP-MS), or colorimetric assays.

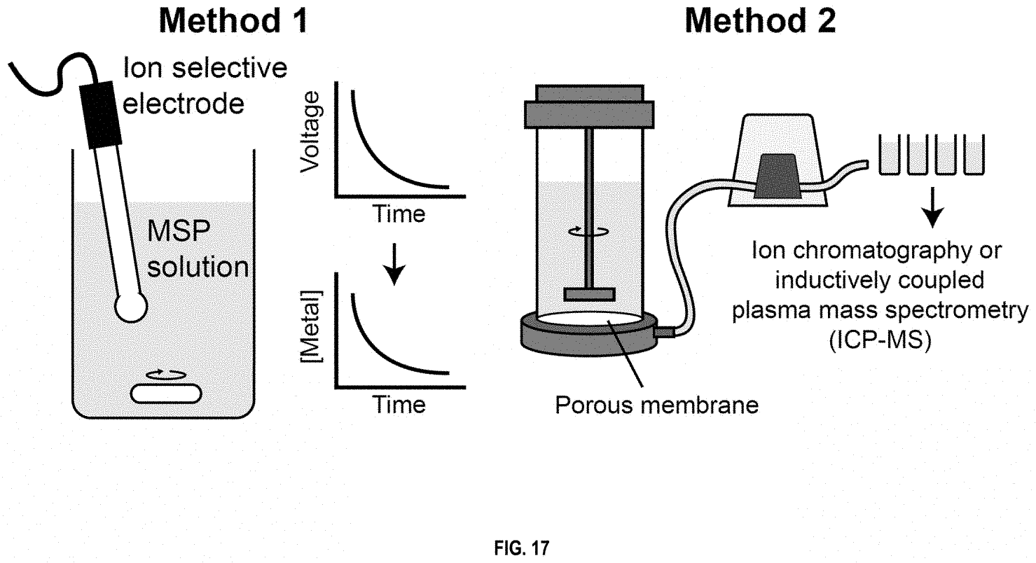

Extraction using MSPs is assessed in batch experiments. Experiments will aim to produce corresponding results as the models assessing the equilibrium extraction of metal (FIG. 6) and the kinetics of extraction (FIGS. 12 and 13). The two possible methods for these experiments are shown in FIG. 17. In the first method, an ion selective electrode, in situ potentiometry, is used to provide on-line measurements quantifying the concentration of extravesicular metal ions using an ion-selective electrode (e.g., to quantify the Cu²⁺ remaining outside of the polymersomes, i.e., the feed concentration or [M²⁺]_{F}) [13], [41]. Entrapped ions inside polymersomes would not interact with the electrode. A pH probe will simultaneously measure the pH outside the polymersomes. These electrodes function based on penetration of the analyte into the electrode itself, and therefore do not detect ions encapsulated by the polymersomes. In Method 2, a porous membrane is used to physically retain MSPs and separate out the extravesicular (raffinate) solution. The ion content of the permeate is then analyzed using ion chromatography or inductively coupled plasma mass spectrometry (ICP-MS). This method mimics the envisioned full-scale process shown in FIG. 5. Another pump can be used to allow for input of feed, wash, and strip solutions.

To complete the mass balance, MSPs are stripped using fresh strip solution (e.g., 1 M HCl) and the Cu²⁺ concentration assayed. Comparison with the quantity of MSPs, as determined based on the initial mass of MSPs and the average size as determined by DLS and cryo-EM [13], will enable estimation of the encapsulated Cu²⁺ concentration prior to stripping.

To better characterize the extraction kinetics with MSPs, parameters such as ligand concentration and strip solution pH are varied. Planar poly(isoprene) films are used as models for comparison. These planar films are first used for equilibrium extraction experiments, essentially testing the extraction behavior of D2EPA in poly(isoprene) as a solvent, enabling calculation of the equilibrium coefficient, K (Eqn. 2) [8]. In these experiments, the system is allowed to reach equilibrium, after which the Cu²⁺ and H⁺ concentrations are assessed. The planar films are also used to measure the diffusivity of Cu²⁺/D2EPA complexes within poly(isoprene). Diffusivity experiments will use simple diffusion cells [26] with the planar film essentially serving as a thick, low-permeability facilitated transport membrane. One cell will hold the Cu²⁺-rich feed solution, while the other cell will hold the initially copper-free strip solution. These experiments can enable determination of the diffusion coefficient, D. The K and D values determined using planar films are compared with the results of MSPs to determine the validity of the model and its assumptions.

### Example 5: Selective Separations of Model Mixtures of Divalent Metal Ions

Building off of Example 4, MSPs are used to separate mixtures of divalent ions, such as Cu²⁺ and Zn²⁺, Cu²⁺ and Mg²⁺, or Zn²⁺ and Mg²⁺. Metal pairs will be chosen to provide a range of intrinsic selectivities (i.e., K₁/K₂).The lab-scale membrane separation method (Method 2 in FIG. 17) is used to demonstrate separations, with permeate samples analyzed by ion chromatography or ICP-MS. Captured metal is recovered using fresh strip solution. Similar to Example 4, experiments with planar poly(isoprene) films are used to determine the equilibrium coefficient and diffusivity for each ion individually. These values are used to model the separations using MSPs, as in FIGS. 14A-14C.

As discussed above, due to the non-equilibrium separation with MSPs, it can be important to control the residence time of the system. Steps are taken to optimize the residence time using the lab-scale membrane setup. For example, parameters affecting the porous membrane can be varied to optimize the total flow rate relative to the solution volume (residence time in a continuous process is the volume divided by the flow rate). These parameters include the membrane type (pore size, membrane material), the transmembrane pressure, and the relative membrane area. The ligand concentration and total concentration of MSPs are also varied to allow for the kinetics to match an experimentally feasible residence time. Finally, an additional pump can be installed to allow for fresh feed solution to be added to the MSP solution, with the flow-rate likely matching the permeate flow. This additional pump can allow for operation similar to a continuous stirred-tank reactor, which is likely beneficial from a processing perspective, and can enable rapid switching between feed, wash, and strip solutions.

### Example 6: Assessment of Effects of Polymer Chemistry and Vesicle Morphology on MSP Performance

Example 6 is performed simultaneously with Examples 4 and 5. Extraction processes are generally dependent on characteristics of the organic phase, meaning the solvent and any added phase modifiers [40]. For MSPs, the “solvent” is essentially the nonpolar polymer block. For poly(isoprene), the extent of crosslinking is varied to assess the effect on mechanical robustness, the equilibrium coefficients for given metal ions, and the metal/ligand diffusivity. Different nonpolar polymer chemistries are also assessed, as described in Example 2. Styrene and alkylstyrene systems may be particularly interesting, as they differ from isoprene in terms of polarity and glass transition temperature. These systems can be more difficult to crosslink, but the high Tg of these systems may make them sufficiently robust. If needed, copolymerization of vinylbenzyl chloride can enable crosslinking chemistries. In addition to the base polymer, commonly used phase modifiers from SX are also assessed. For example, tributyl phosphate has been used as a phase modifier for SX with D2EHPA in kerosene [40].

The models discussed thus far for MSPs have largely ignored the hydrophilic block, assuming that any resistance for metal transport through the water-solubilized hydrophilic polymer layer is negligible. Rather, the hydrophilic block is assumed to solely aid with the self-assembly of the polymersome and the dispersibility (i.e., lack of aggregation) of the resulting polymersomes. However, the headgroups of lipids in lipid bilayers (analogous to the hydrophilic block in polymersomes) can in some instances play an important role in membrane permeation, largely by sterically obstructing solute penetration into the nonpolar layer [14], [15], [42]. The effect of the hydrophilic block is assessed in MSPs by varying the chemistry and chain length of the hydrophilic block. Deviations in MSP performance when compared with K and 1) values obtained using pure poly(isoprene) films are then putatively assigned to steric exclusion by the hydrophilic block. To test this directly, the relevant amphiphilic block polymers are mixed with the planar poly(isoprene) films, whereupon the block polymers will segregate to the water/poly(isoprene) surface to minimize the interfacial energy [43]. Crosslinking can stabilize the block polymers at the surface, which is confirmed using infrared spectroscopy, X-ray photoelectron spectroscopy, and water contact angle. These planar films with surface-bound hydrophilic polymer chains are then used to determine K and D, enabling direct comparison with values obtained using pure poly(isoprene).

Structural attributes of the polymersomes may also play an important role in mechanical robustness and the kinetics of separations. The thickness of the vesicle wall, in particular, is varied by changing the total polymer chain length and the relative fraction of the hydrophobic block and assessed [16]. Thickness factors directly into the flux (Eqn. 8), and therefore a direct comparison between wall thickness and flux is fundamentally important. Wall thickness is estimated using cryo-EM [44]. The vesicle diameter defines the ratio between MSP surface area and volume, which will inherently affect the kinetics. This effect is assessed, with control of the vesicle size obtained by extrusion through membranes of different pore size (e.g., 100 nm, 200 nm).

### Example 7: Assessment of Covalent Linkage of Ligands to the Polymer Backbone

Examples 2-6 deal with facilitated transport membranes that are directly analogous to solvent extraction, with freely diffusing ligands, metal/ligand complexes, and cosolvents (phase modifiers). This format is experimentally accessible, easily tunable, and has tremendous potential to be practical on an industrial scale. However, MSPs with this design may still leach ligand into the aqueous solution over time—even if MSPs are fully retained by the porous membranes-due to the non-zero solubility of ligand in water. This potential problem also affects SX. In practice, it is likely that fresh addition of ligand to the MSP solution could allow for recovery of the desired performance. Such leaching of ligand and performance recovery with addition of fresh ligand is tested in this Example.

An alternative strategy that MSPs enable is to covalently link the ligand to the hydrophobic polymer backbone, eliminating any possibility of ligand loss into the aqueous phase [45]. In this type of system, the ligands are not able to diffuse between the interfaces, forcing the metal ion to “hop” between ligands [45]. Transport under this mechanism can be more complex, but can still e rapid. Use of extremely pensive ligands may incentivize covalent linkage of ligands. As a proof-of-concept, maleic anhydride is grafted onto the poly(isoprene) polymer block through the ene reaction [46], [47], after which hydrolysis using NaOH will yield a di-carboxylic acid as the polymer-bound ligand (Scheme V).

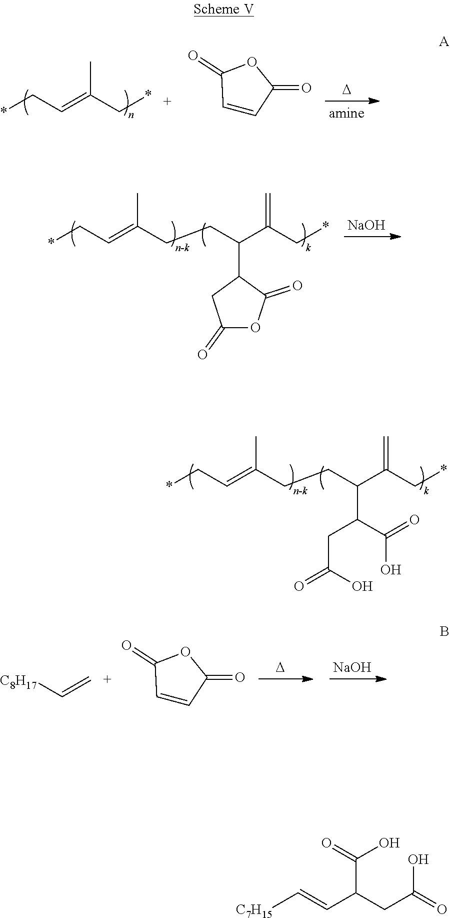

Scheme V (A) shows grafting of carboxyl groups to poly(isoprene) blocks using maleic anhydride [47]. The resulting carboxylic acids can serve as carriers that are tethered or covalently linked to the polymer backbone.

For comparison, freely diffusing di-carboxylic acid ligands will be synthesized in a similar fashion using decene or another long-chain alkene instead of a block polymer containing poly(isoprene). Scheme V (B) shows synthesis of a chemically similar freely-diffusing carrier using maleic anhydride and 1-decene, or a similar aliphatic alkene [46]. The metal removal efficiency and kinetics are characterized for the polymer-bound system and freely diffusing system in a similar fashion as laid out in Examples 4 and 5. In particular, MSPs and planar films are both used and results are compared with transport models [45].

### Example 8: Solvent Extraction of Copper Ions Using HNAPO

In Example 8, an experiment was conducted to show extraction of copper using a solvent, a ketoxime solution Lix 84-I (supplied by BASF), containing 2-hydroxy-5-nonylacetophenone oxime (HNAPO) as the active agent that binds selectively to Cu²⁺. The following procedural steps were taken for this experiment:
Mix 10 mL 15.7 mM CuSO₄ (1 g/L Cu) (supplied by Fisher Scientific) with 5 mL hexane+Lix 84-I
Separate the phases; and
Measure Cu remaining by using UV-Vis spectroscopy with polyethylenimine (PEI) as the color-enhancing ligand.

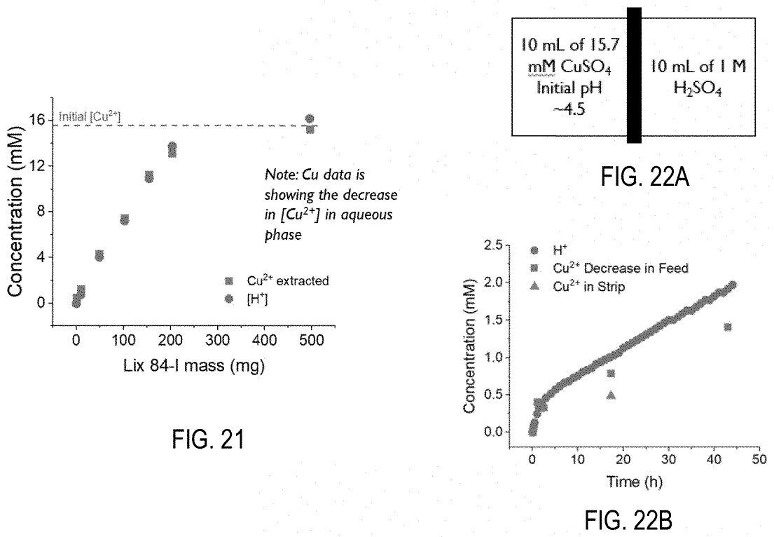

As shown in FIG. 21, a graph plot of [H⁺] and Cu²⁺ ion concentrations versus the solvent mass provides the results of the experiment. Based on the initial slope of Cu extraction provided by the graph plot and assuming 1:2 Cu:HNAPO binding, the Lix 84-I solvent was determined as containing 38 wt. % HNAPO for copper ion binding.

### Example 9: Planar-Facilitated Transport Membrane Film (Control)

In Example 9, an experiment was conducted to observe facilitated transport characteristics associated with a control sample, a membrane containing a poly(styrene)-poly(butadiene)-poly(styrene) (SBS) commercial triblock polymer (D1157, 30 wt % polystyrene, supplied by Kraton) film with 30 wt % Lix 84-I. The membrane, with a 1.77 cm² membrane area (˜5 mg Lix 84-I in active membrane area), was positioned between two solutions: (1) 10 mL of 15.7 mM CuSO₄, Initial pH˜4.5; (2) 10 mL of 1 M H₂SO₄, as shown in FIG. 22A

The results of this experiment are shown in FIG. 22B. The kinetics associated with ion transport across the membrane were relatively slow, with ˜1 mM removal every 2 days, but it clearly facilitated the transport of ions. The membrane also showed very low H+ leakage (0.08 mM over 7 days) from 1 M H2SO4 into 1 M NaCl, measured in the absence of Cu²⁺.

### Example 10: Sorbitan Trioleate-Stabilized Capsules with HNAPO

In Example 10, an experiment was conducted to observe copper ion uptake and retention using Span 85-stabilized capsules. The following procedural steps were taken for this experiment:
Obtain approximately 0.52 g SBS (D1157, Kraton) in DCM, 200 mg Span 85 and 158 mg Lix 84-I (22 wt %);
Mix 4 mL 10% SBS in DCM, Lix 84-I, and Span 85;
Probe sonicate with 1 mL 1 M CuSO₄ to form water-in-oil emulsion; Vortex in 20 mL 2% PVA (13-23 kDa, 88% hydrolyzed), and 1 M NaCl to form water-in-oil-in-water emulsion; and
Pour into 500 mL 0.1% PVA, 1 M NaCl, 35° C. with overhead stirrer to dilute and allow DCM to evaporate for >1 h.

The above described formulation produced relatively stable W/O emulsions. PVA was used to stabilize oil droplet in water. Also, as a preconditioning step, the capsules were soaked in 1 M H₂SO₄ for 1-2 days to exchange Cu²⁺ with H⁺. Capsules went from dark green to white during this time, due to release of Cu²⁺.

Following preconditioning, the Span 85-stabilized capsules were mixed with 20 mL 15.7 mM CuSO₄.

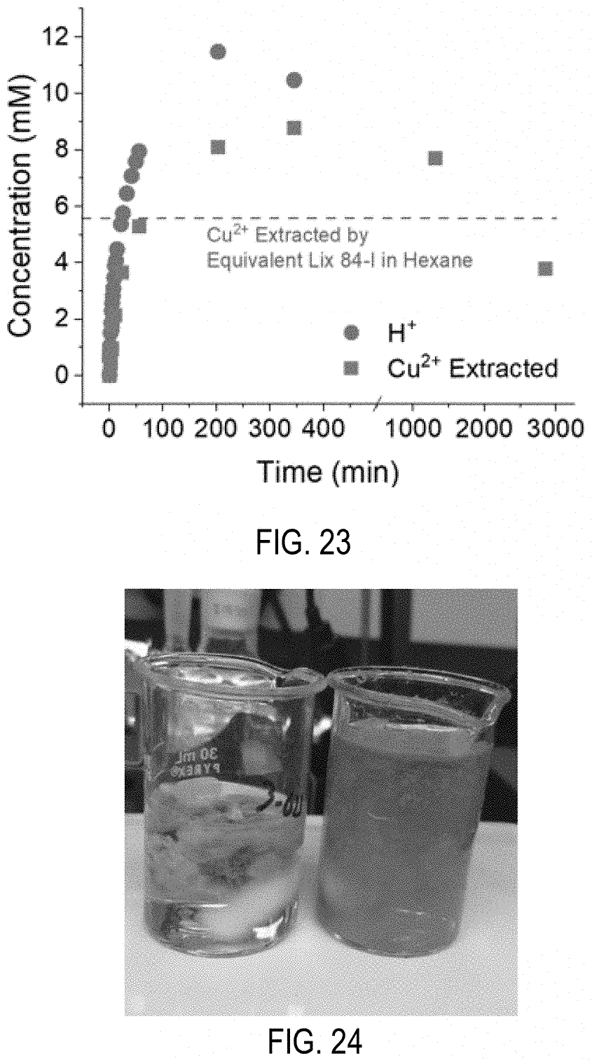

The results of this experiment are provided in FIG. 23. The small molecule (Span 85) stabilized capsules demonstrated facilitated transport, but shows signs of instability in terms of dispersion in water and leakage of interior solution. The kinetics with the capsules were notably faster than the kinetics observed with the (control) planar membrane (see Example 9), however, the different Lix 84-I amounts used between the two studies may have contributed to the kinetics difference.

Copper uptake occurred on the order of hours, and exhibited clumped-up particles (see FIG. 24, on left side). Span 85-stabilized particles agglomerated to form cm-sized flocs, which may be due to Span 85 diffusion to outer PVA-stabilized interface, destabilizing interface. The Cu²⁺ uptake was observed as exceeding the expected copper extraction by an equivalent amount of Lix 84-I (see Example 8), which strongly suggests facilitated transport of copper ions to the interior acid solution.

It was observed that the H⁺ concentration exceeded copper uptake (was ˜1:1 in hexane experiment), which suggested some leakage of inner acid solution. Furthermore, it was observed that the copper released over time back into aqueous solution, possibly due to leakage of interior solution due to osmotic swelling of interior and/or surfactant instability.

### Example 11: PVB3MA-PI-Stabilized Capsules with HNAPO

In Example 11, experiments were conducted to observe copper ion uptake and retention using poly(vinylbenzyltrimethylammonium chloride)-poly(isoprene) (PVB3MA-PI)-stabilized capsules.

The following procedural steps were performed for the experiment:
Obtain approximately 0.52 g SBS (D1157, Kraton) in DCM, 20 mg PVB3MA-PI and 150 mg Lix 84-I (22 wt %);
Mix 4 mL 10% SBS in DCM, Lix 84-I, and PVB3MA-PI;
Probe sonicate with 1 mL 1 M CuSO₄ to form water-in-oil emulsion;
Vortex in 20 mL 2% PVA (13-23 kDa, 88% hydrolyzed), 1 M NaCl to form water-in-oil-in-water emulsion; and
Pour into 500 mL 0.1% PVA, 1 M NaCl, 35° C. with overhead stirrer to dilute and allow DCM to evaporate for >1 h.

The above described formulation produced relatively stable W/O emulsions. PVA was used to stabilize oil droplet in water. Also, as a preconditioning step, the capsules were soaked in 1 M H2SO4 to exchange Cu2+ with H+. After soaking in 1 M H2SO4 for 4 days, the particles were still observed as slightly green, signifying that the capsules still contain Cu²⁺, indicating that the Cu²⁺ release for PVB3MA-PI-stablised capsules was slower than that observed for Span 85-stabilized capsules.

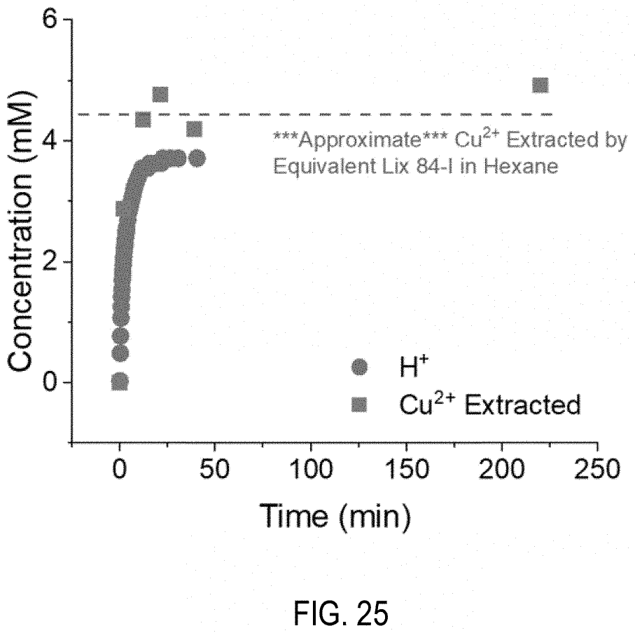

After preconditioning, the PVB3MA-PI Stabilized capsules were mixed w/20 mL 15.7 mM CuSO₄. The results of this experiment are provided in FIG. 25. The polymer (PVB3MA-PI) stabilized capsules were found to be stable and exhibited rapid uptake. Cu²⁺ uptake occurred through well-dispersed particles relatively rapidly and reached equilibrium in 5-10 min.

Low total uptake and slow/incomplete stripping suggest that the cationic brush layer in its structure may hinder Cu²⁺ transport. The kinetics with the capsules were notably faster than the kinetics observed with the (control) planar membrane (see Example 9). However, the different Lix 84-I amounts used between the two studies may have contributed to the kinetics difference.

It was also observed that the PVB3MA-PI stabilized particles stayed well dispersed (see FIG. 24, shown on right side).

Furthermore, the amount of [H+] was observed as being approximately equivalent to the amount of [Cu²⁺] removed, suggesting minimal leakage of the internal acid.

The equilibrium removal of [Cu²⁺] was similar to that expected by extraction using an equivalent amount of Lix 84-I (see Example 8). It was noted that during this experiment, some capsules were lost due to spillage. In the absence of any loss, the expected extraction would have been 5.8 mM.

### Example 12: PVB3MA-PI-Stabilized Capsules

In Example 11, experiments were conducted to show carboxyfluorescein (CF) encapsulation of the PVB3MA-PI-stabilized capsules.

The following procedural steps were performed for the experiment:
Obtain approximately 0.52 g SBS (D1157, Kraton) in DCM, and 20 mg PVB3MA-PI;
Mix 4 mL 10% SBS in DCM, and PVB3MA-PI;
Probe sonicate with 10 mM CF, 1 M NaCl as the inner solution (instead of 1 mL 1 M CuSO₄) to form water-in-oil emulsion;
Vortex in 20 mL 2% PVA (13-23 kDa, 88% hydrolyzed), 1 M NaCl to form water-in-oil-in-water emulsion; and
Pour into 500 mL 0.1% PVA, 1 M NaCl, 35° C. with overhead stirrer to dilute and allow DCM to evaporate for >1 h.

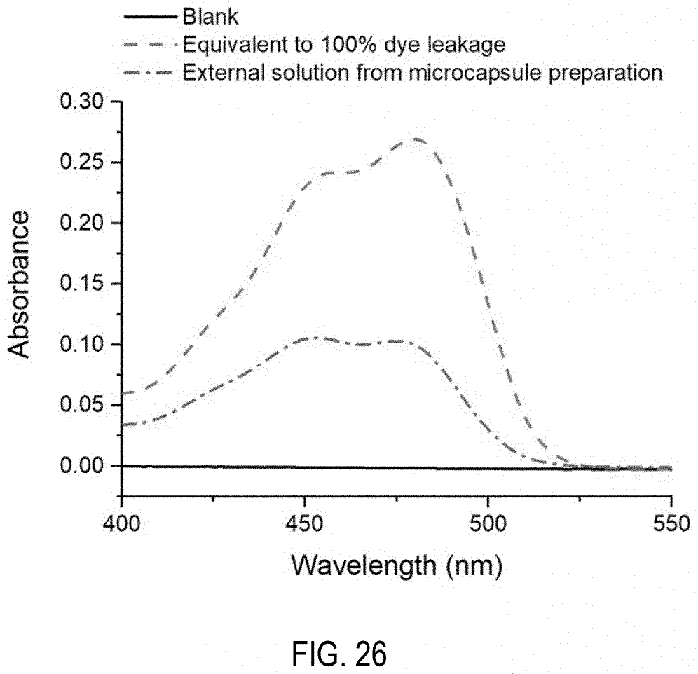

The above described formulation produced relatively stable W/O emulsions that formed yellow particles, which qualitatively demonstrates that CF encapsulation occurred. FIG. 26 shows the level of CF present in the external aqueous solution (excluding the formed particles), which was used to determine the amount of particles stabilized by PVB3MA-PI. The results suggests that approximately 50% encapsulation occurred.

### REFERENCES

1. Rohrig, B., Smartphones: Smart Chemistry. ChemMatters 2015. PDF.
2. Reck, B. K.; Graedel, T. E., Challenges in Metal Recycling. Science 2012, 337, 690-695.
3. Basic Research Needs for Environmental Management; Office of Science, Department of Energy: 2016. PDF.
4. Danesi, P. R., Separation of Metal Species by Supported Liquid Membranes. Separation Science and Technology 1984, 19, 857-894.
5. Tavlarides, L. L.; Bae, J. H.; Lee, C. K., Solvent Extraction, Membranes, and Ion Exchange in Hydrometallurgical Dilute Metals Separation. Separation Science and Technology 1987, 22, (2-3), 581-617.
6. Brown, S. J. Caustic Side Solvent Extraction at the Savannah River Site: Operating Experience and Lessons Learned, WM2010, Phoenix, Ariz., 2010. PDF.
7. Cussler, E. L., Facilitated Transport. In Membrane Separation Systems: Recent Developments and Future Directions, Baker, R. W., Ed. William Andrew: 1991.
8. Raghuraman, B.; Tirmizi, N.; Wiencek, J., Emulsion Liquid Membranes for Wastewater Treatment: Equilibrium Models for Some Typical Metal-Extractant Systems. Environmental Science and Technology 1994, 28, 1090-1098.
9. Baker, R. W., Membrane Technology and Applications. John Wiley & Sons, Ltd: 2012; p 575.
10. Nghiem, L. D.; Mornane, P.; Potter, I. D.; Perera, J. M.; Cattrall, R. W.; Kolev, S. D., Extraction and transport of metal ions and small organic compounds using polymer inclusion membranes (PIMs). Journal of Membrane Science 2006, 281, (1-2), 7-41.
11. Discher, B. M.; Won, Y-Y; Ege, D. S.; Lee, J. C.-M.; Bates, F. S.; Discher, D. E.; Hammer, D. A., Polymersomes: Tough Vesicles Made from Diblock Copolymers. Science 1999, 284, 1143-1146.
12. Mecke, A.; Dittrich, C.; Meier, W., Biomimetic membranes designed from amphiphilic block copolymers. Soft Matter 2006, 2, (9), 751.
13. Werber, J. R.; Elimelech, M., Permselectivity limits of biomimetic desalination membranes. Science Advances 2018, 4, eaar8266.
14. Mathai, J. C.; Tristram-Nagle, S.; Nagle, J. F.; Zeidel, M. L., Structural determinants of water permeability through the lipid membrane. J. Gen. Physiol. 2008, 131, 69-76.
15. Xiang, T.-X.; Anderson, B. D., Liposomal drug transport: A molecular perspective from molecular dynamics simulations in lipid bilayers. Adv. Drug Deliv. Rev. 2006, 58, 1357-1378.
16. Bermudez, H.; Brannan, A. K.; Hammer, D. A.; Bates, F. S.; Discher, D. E., Molecular Weight Dependence of Polymersome Membrane Structure, Elasticity, and Stability. Macromolecules 2002, 35, 8203-8208.
17. Discher, B. M.; Bermudez, H.; Hammer, D. A.; Discher, D. E.; Won, Y-Y; Bates, F. S., Cross-linked Polymersome Membranes: Vesicles with Broadly Adjustable Properties. The Journal of Physical Chemistry B 2002, 106, 2848-2854.
18. Chidanguro, T.; Ghimire, E.; Liu, C. H.; Simon, Y C., Polymersomes: Breaking the Glass Ceiling? Small 2018, 1802734, 1-17.
19. Le Meins, J. F.; Sandre, O.; Lecommandoux, S., Recent trends in the tuning of polymersomes' membrane properties. European Physical Journal E 2011, 34.
20. Nardin, C.; Hirt, T.; Leukel, J.; Meier, W., Polymerized ABA triblock copolymer vesicles. Langmuir 2000, 1035-1041.
21. Werber, J. R.; Osuji, C. O.; Elimelech, M., Materials for next-generation desalination and water purification membranes. Nat. Rev. Mater 2016, 1, (5), 16018.
22. Finkelstein, A., Water movement through lipid bilayers, pores, and plasma membranes: Theory and reality. Wiley: New York, N.Y., 1987; p 228.
23. Israelachvili, J. N., Intermolecular and Surface Forces. Elsevier: Amsterdam, 2011; p 674.
24. Hoek, E. M. V.; Kim, A. S.; Elimelech, M., Influence of crossflow membrane filter geometry and shear rate on colloidal fouling in reverse osmosis and nanofiltration separations. Environ. Eng. Sci. 2002, 19, 357-372.
25. Schock, G.; Miquel, A., Mass transfer and pressure loss in spiral wound modules. Desalination 1987, 64, 339-352.
26. Cussler, E. L., Diffusion: Mass Transfer in Fluid Systems. Cambridge University Press: Cambridge, UK, 2009.
27. Larsen, M. B.; Wang, S.-j.; Hillmyer, M. A., Poly(allyl alcohol) Homo- and Block Polymers by Postpolymerization Reduction of an Activated Polyacrylamide. J. Am. Chem. Soc. 2018, 140, (38), 11911-11915.
28. Saba, S. A.; Lee, B.; Hillmyer, M. A., Tricontinuous Nanostructured Polymers via Polymerization-Induced Microphase Separation. ACS Macro Lett. 2017, 6, 1232-1236.
29. Germack, D. S.; Wooley, K. L., Isoprene Polymerization via Reversible Addition Fragmentation Chain Transfer Polymerization. Journal of Polymer Science Part A: Polymer Chemistry 2007, 45, 4100-4108.
30. Larsen, M. B.; Herzog, S. E.; Quilter, H. C.; Hillmyer, M. A., Activated Polyacrylamides as Versatile Substrates for Postpolymerization Modification. ACS Macro Lett. 2018, 7, (1), 122-126.
31. Gramlich, W. M.; Hillmyer, M. A., Catalytic synthesis and post-polymerization functionalization of conjugated polyisoprene. Polymer Chemistry 2011, 2, 2062-2067.
32. Bolton, J. M.; Hillmyer, M. A.; Hoye, T. R., Sustainable thermoplastic elastomers from terpene-derived monomers. ACS Macro Letters 2014, 3, 717-720.
33. Hilschmann, J.; Kali, G., Bio-based polymyrcene with highly ordered structure via solvent free controlled radical polymerization. European Polymer Journal 2015, 73, 363-373.
34. Iacob, C.; Yoo, T.; Runt, J., Molecular Dynamics of Polyfarnesene. Macromolecules 2018, 51, (13), 4917-4922.
35. Matsushima, S.; Takano, A.; Takahashi, Y; Matsushita, Y, Precise synthesis of a series of poly(4-n-alkylstyrene)s and their glass transition temperatures. Journal of Polymer Science, Part B: Polymer Physics 2017, 55, (9), 757-763.
36. Lim Soo, P.; Eisenberg, A., Preparation of block copolymer vesicles in solution. Journal of Polymer Science Part B: Polymer Physics 2004, 42, 923-938.
37. Cytec, Inc. Technical Guide for Cyanex 272 Extractant; 2008.
38. Pata, V; Ahmed, F.; Discher, D. E.; Dan, N., Membrane Solubilization by Detergent: Resistance Conferred by Thickness. Langmuir 2004, 20, 3888-3893.
39. Carlsen, A.; Glaser, N.; Le Meins, J.-F.; Lecommandoux, S., Block copolymer vesicle permeability measured by osmotic swelling and shrinking. Langmuir 2011, 27, 4884-90.
40. Cheng, C. Y, Purification of synthetic laterite leach solution by solvent extraction using D2EHPA. Hydrometallurgy 2000, 56, 369-386.
41. Paula, S.; Volkov, A. G.; Van Hoek, A. N.; Haines, T. H.; Deamer, D. W., Permeation of protons, potassium ions, and small polar molecules through phospholipid bilayers as a function of membrane thickness. Biophys. J. 1996, 70, 339-348.
42. Nagle, J. F.; Mathai, J. C.; Zeidel, M. L.; Tristram-Nagle, S., Theory of Passive Permeability through Lipid Bilayers. J. Gen. Physiol. 2008, 131, 77-85.
43. Asatekin, A.; Kang, S.; Elimelech, M.; Mayes, A. M., Anti-fouling ultrafiltration membranes containing polyacrylonitrile-graft-poly(ethylene oxide) comb copolymer additives. Journal of Membrane Science 2007, 298, 136-146.
44. Won, Y Y; Brannan, A. K.; Davis, H. T.; Bates, F. S., Cryogenic transmission electron microscopy (cryo-TEM) of micelles and vesicles formed in water by poly(ethylene oxide)-based block copolymers. J. Phys. Chem. B 2002, 106, 3354-3364.
45. Cussler, E. L.; Aris, R.; Bhown, A., On the limits of facilitated diffusion. Journal of Membrane Science 1989, 43, 149-164.
46. Benn, F. R.; Dwyer, J.; Chappell, I., The Ene reaction of maleic anhydride with alkenes. Journal of the Chemical Society, Perkin Transactions 2 1977, 533-535.
47. Chino, K.; Ashiura, M., Thermoreversible cross-linking rubber using supramolecular hydrogen-bonding networks. Macromolecules 2001, 34, 9201-9204.

### Other Embodiments

A number of embodiments of the invention have been described. Nevertheless, it will be understood that various modifications may be made without departing from the spirit and scope of the invention. For example, other synthetic methods can be used for making the polymeric capsules. Accordingly, other embodiments, aspects, advantages, and modifications are within the scope of the following claims.

What is claimed is:

1. A capsule comprising:
a polymeric shell encasing an inner chamber; and
a lipophilic ligand within the polymeric shell.

2. The capsule of claim 1, wherein the shell comprises one or more amphiphilic block polymers.

3. The capsule of any one of claim 2, wherein the one or more amphiphilic block polymers comprises a hydrophobic block comprising a monomer selected from isoprene, chloroprene, butadiene, myrcene, farnesene, citrenellol, styrenic derivatives, acrylic derivatives, acrylamide derivatives, and siloxane derivatives, and combinations thereof.

4. The capsule of claim 1, wherein the polymeric shell comprises at least one polymer selected from poly(isoprene), poly(chloroprene), poly(butadiene), poly(myrcene), poly(farnesene), poly(citrenellol), hydrogenated poly(isoprene), hydrogenated poly(butadiene), polyethylene, polypropylene, polymers from styrenic derivatives, polymers from acrylic derivatives, polymers from acrylamide derivatives, polymers from siloxane derivatives, and polydimethylsiloxane.

5. The capsule of claim 1, wherein the lipophilic ligand is selected from oxime derivatives, phosphoric acid derivatives, phosphinic acid derivatives, phosphonic acid derivatives, diketone derivatives, amine derivatives, ketone derivatives, polyether derivatives, crown ether derivatives, cryptand derivatives, calixarene derivatives, and combinations thereof.

6. The capsule of claim 1, further comprising a strip solution contained within the inner chamber of the capsule.

7. The capsule of claim 1, wherein the lipophilic ligand interacts with metal ions.

8. The capsule of claim 1, wherein the lipophilic ligand is a freely diffusing ligand.

9. The capsule of claim 1, wherein the lipophilic ligand is covalently bonded to a polymer in the shell.

10. The capsule of claim 1, wherein the shell comprises a water-insoluble polymer and one or more surfactants.

11. The capsule of claim 10, wherein the one or more surfactants comprise amphiphilic polymers.

12. The capsule of claim 1, wherein the capsule comprises a multi-block copolymer comprising a hydrophilic segment, a hydrophobic segment, and an acidic segment.

13. A method of extracting target ions from a mixed solution comprising:
exposing the mixed solution to polymeric capsules to produce a second solution, wherein the capsules comprise:
a polymeric shell encasing an inner chamber;
a lipophilic ligand within the polymeric shell; and
a first strip solution contained within the inner chamber of the capsule.

14. The method of claim 13, wherein the lipophilic ligand specifically binds the target ion.

15. The method of claim 13, further comprising removing the second solution from the capsules.

16. The method of claim 13, further comprising:
exposing the capsules to a second strip solution to obtain a solution enriched in the target metal ion and regenerate the first strip solution within the capsules; and
collecting the target ions.

17. The method of claim 13, wherein removing the second solution comprises washing to remove non-target ions by using a size-based separation technique or a packed bed technique.

18. The method of claim 13, wherein the lipophilic ligand is selected from oximes, phosphoric acid derivatives, phosphinic acid derivatives, phosphonic acid derivatives, diketone derivatives, amine derivatives, ketone derivatives, polyether derivatives, crown ether derivatives, cryptand derivatives, and calixarene derivatives.

19. The method of claim 13, wherein the first strip solution, second strip solution, or combination thereof, is an acid solution, and optionally, wherein the acid is hydrochloric acid or sulfuric acid.
